(19) United States
(12) Patent Application Publication
(10) Pub. No.: US 2013/0113436 A1
(43) Pub. Date: May 9, 2013

(54) CHARGE CONTROLLING METHOD AND DISCHARGE CONTROLLING METHOD, CHARGING APPARATUS CONTROLLER AND DISCHARGING APPARATUS CONTROLLER, AND CHARGE CONTROLLING PROGRAM AND DISCHARGE CONTROLLING PROGRAM

(71) Applicant: Sony Corporation, Tokyo (JP)

(72) Inventor: Yoshihito Ishibashi, Tokyo (JP)

(73) Assignee: Sony Corporation, Tokyo (JP)

(21) Appl. No.: 13/664,827

(22) Filed: Oct. 31, 2012

(30) Foreign Application Priority Data
Nov. 7, 2011 (JP) 2011-243966

(51) Int. Cl. H02J 7/00

(52) U.S. Cl. 320/136; 320/138; 320/135

(57) ABSTRACT

Disclosed herein is a charge controlling method, wherein, when charging into at least one of a plurality of charging apparatus each including a battery is to be started, if it is detected that at least one of the charging apparatus is connected or disconnected, then charging into all of the charging apparatus is stopped.

### BACKGROUND

The present disclosure relates to a charge controlling method and a discharge controlling method, a charging apparatus controller and a discharging apparatus controller, and a charge controlling program and a discharge controlling program. More particularly, the present disclosure relates to a charge controlling method and a discharge controlling method, a charging apparatus controller and a discharging apparatus controller, and a charge controlling program and a discharge controlling program which allow the number of batteries electrically connected to a controller to be changed while charging into batteries having an electric connection to the controller or discharging from the batteries is being carried out.

Secondary batteries represented by a lithium-ion battery have spread widely. Also investigations for controlling charging and discharging into and from a plurality of secondary batteries are conducted actively.

For example, Japanese Patent Laid-Open No. 2005-237064 discloses a vehicle controller which acquires a battery remaining capacity of a plurality of battery packs carried on a vehicle and changes over a battery for traveling between or among the battery packs based on ranks set in response to the remaining capacities of the battery packs. It is to be noted that Japanese Patent Laid-Open No. 2004-328960 discloses a technique of determining ranks for a plurality of electronic apparatus in advance and limiting, upon power failure, electric power supply to the plural electronic apparatus in order beginning with the electronic apparatus having a comparatively low rank.

### SUMMARY

Generally, the number of secondary batteries connected to a control apparatus upon charging into the secondary batteries or upon discharging from the secondary batteries is fixed, in other words, usually it is not supposed that the number of secondary batteries connected to the control apparatus varies halfway of charging into the secondary batteries or of discharging from the secondary batteries.

According to a first embodiment of the present disclosure, there is provided a charge controlling method, wherein, when charging into at least one of a plurality of charging apparatus each including a battery is to be started, if it is detected that at least one of be charging apparatus is disconnected, then charging into all of the charging apparatus is stopped.

According to a second embodiment of the present disclosure, there is provided a discharge controlling method, wherein, when discharging from at least one of a plurality of discharging apparatus each including a battery is to be started, if disconnection of at least one of the discharging apparatus is detected, then discharging from one of the discharging apparatus is continued while discharging from all of the remaining discharging apparatus is stopped.

According to a third embodiment of the present disclosure, there is provided a charging apparatus controller, wherein, when the charging apparatus controller issues an instruction to start charging into at least one of a plurality of charging apparatus each including a battery and being capable of being connected to and disconnected from the charging apparatus controller, if new connection or disconnection of at least one of the charging apparatus is detected, the charging apparatus controller issues an instruction to stop charging to all of the charging apparatus.

According to a fourth embodiment of the present disclosure, there is provided a discharging apparatus controller, wherein, when the discharging apparatus controller issues an instruction to start discharging to at least one of a plurality of discharging apparatus each including a battery and capable of being connected to and disconnected from the discharging apparatus controller, if new connection or disconnection of at least one of the discharging apparatus is detected, then the discharging apparatus controller causes at least one of the discharging apparatus to continue discharging and issues an instruction to stop discharging to all of the remaining discharging apparatus.

According to a fifth embodiment of the present disclosure, there is provided a charge controlling program for causing a computer to execute stopping, when charging into at least one of a plurality of charging apparatus each including a battery is to be started, charging into all of the charging apparatus if new connection or disconnection of at least one of the charging apparatus is detected.

According to a sixth embodiment of the present disclosure, there is provided a discharge controlling program for causing a computer to execute continuing, when discharging from at least one of a plurality of discharging apparatus each including a battery is to be started, discharging from one of the discharging apparatus while stopping discharging from all of the remaining discharging apparatus if new connection or disconnection of at least one of the discharging apparatus is detected.

With at least one of the first to sixth embodiments, while charging into or discharging from the batteries having an electric connection to the controller is being carried out, the number of those batteries which are electrically connected to the controller can be changed.

### BRIEF DESCRIPTION OF THE DRAWINGS

FIG. 1 is a block diagram showing an example of a configuration of a system;

FIG. 2 is a block diagram showing an example of a configuration of a control unit;

FIG. 3 is a block diagram showing an example of a configuration of a power supply system of the control unit;

FIG. 4 is a circuit diagram showing an example of a particular configuration of a high voltage is power supply circuit of the control unit;

FIG. 5 is a block diagram showing an example of a configuration of a battery unit;

FIG. 6 is a block diagram showing an example of a configuration of a power supply system of the battery unit;

FIG. 7 is a circuit diagram showing an example of a particular configuration of a charger circuit of the battery unit;

FIG. 8A is a graph illustrating a voltage-current characteristic of a solar cell, and FIG. 8B is a graph, particularly a P-V curve, representative of a relationship between the terminal voltage of the solar cell and the generated electric power of the solar cell in the case where a voltage-current characteristic of the solar cell is represented by a certain curve;

FIG. 9A is a graph illustrating a variation of an operating point with respect to a change of a curve representative of a voltage-current characteristic of a solar cell, and FIG. 93 is a block diagram showing an example of a configuration of a control system wherein cooperation control is carried out by a control unit and a plurality of battery units;

FIG. 10A is a graph illustrating a variation of an operating point when cooperation control is carried out in the case where the illumination intensity noon a solar cell decreases, and FIG. 10B is a graph illustrating a variation of an operating point when cooperation control is carried out in the case where the load as viewed from the solar cell increases;

FIG. 11A is a graph illustrating a variation of an operating point when cooperation control is carried out in the case where both of the illumination intensity upon the solar cell and the load as viewed from the solar cell vary, and FIG. 11B is an example of a configuration for communication connection between a control unit and a plurality of battery units;

FIGS. 12A to 12D and 13A to 13D are diagrammatic views illustrating relationships of ranks for discharging to a discharging instruction to battery units and discharging from battery units;

FIG. 14 is a flow chart illustrating an example of processing in the case where a charging instruction is given to a plurality of battery units based on ranks for charging;

FIGS. 15A and 15B are schematic views illustrating relationships of ranks for charging to a charging instruction to battery units and charging into battery units; and

FIG. 16 is a flow chart illustrating an example of processing in the case where a discharging instruction is provided to a plurality of battery units based on ranks for discharging.

### DETAILED DESCRIPTION OF THE PREFERRED EMBODIMENT

In the following, an embodiment of the present disclosure is described with reference to the accompanying drawings. It is to be noted that the description is given in the following order.

### <1. Embodiment>

### <2. Modifications>

It is to be noted that the embodiment and the modifications described below are specific preferred examples of the present disclosure, and the present disclosure is not limited to the embodiment and the modifications.

### 1. EMBODIMENT

### Configuration of the System

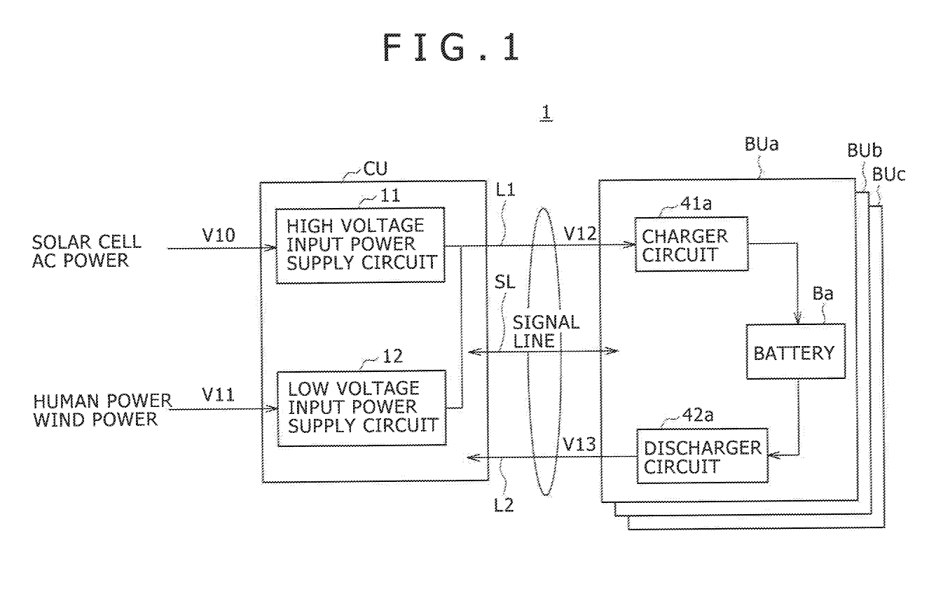

FIG. 1 shows an example of a configuration of a control system according to the present disclosure. The control system is configured from one or a plurality of control units CU and one or a plurality of battery units BU. The control system 1 shown as an example in FIG. 1 includes one control unit CU, and three battery units BUa, BUb and BUc. When there is no necessity to distinguish the individual battery units, each battery unit is suitably referred to as battery unit BU.

In, the control system 1, it is possible to control the battery units BU independently of each other. Further, the battery units BU can be connected independently of each other in the control system 1. For example, in a state in which the battery unit BUa and the battery unit BUb are connected in the control system 1, the battery unit BUc can be connected newly or additionally in the control system 1. Or, in a state in which the battery units BUa to BUc are connected in the control system 1, it is possible to remove only the battery unit BUb from the control system 1.

The control unit CU and the battery units BU are individually connected to each other by electric power lines. The power lines include, for example, an electric power line L1 by which electric power is supplied from the control unit CU to the battery units BU and another electric power line L2 by which electric power is supplied from the battery units BU to the control unit CU.

Thus, bidirectional communication is carried out through a signal line SL between the control unit CU and the battery units BU. The communication may be carried out in conformity with such specifications as, for example, the SMBus (System. Management Bus) or the UART (Universal Asynchronous Receiver-Transmitter).

The signal line SL is configured from one or a plurality of lines, and a line to be used is defined in accordance with an object thereof. The signal line SL is used commonly, and the battery units BU are connected to the signal line SL. Each battery unit BU analyzes the header part of a control signal transmitted thereto through the signal line SL to decide whether or not the control signal is destined for the battery unit BU itself. By suitably setting the level and so forth of the control signal, a command to the battery unit BU can be transmitted. A response from a battery unit BU to the control unit CU is transmitted also to the other battery units BU. However, the other battery units BU do not operate in response to the transmission of the response. It is to be noted that, while it is assumed that, in the present example, transmission of electric power and communication are carried out by means of wires, they may otherwise be carried out by radio.

### [General Configuration of the Control Unit]

The control unit CU is configured from a high voltage input power supply circuit 11 and a low voltage input power supply circuit 12. The control unit CU has one or a plurality of first devices in the present example, the control unit CU has two first devices, which individually correspond to the high voltage input power supply circuit 11 and the low voltage input power supply circuit 12. It is to be noted that, although the terms “high voltage” and “low voltage” are used herein, the voltages to be inputted to the high voltage input power supply circuit 11 and the low voltage input power supply circuit 12 may be included in the same input range. The input ranges of the voltages which can be accepted by the high voltage input power supply circuit 11 and the low voltage input power supply circuit 12 may overlap with each other.

A voltage generated by an electric power generation section which generates electricity in response to the environment is supplied to the high voltage input power supply circuit 11 and the low voltage input power supply circuit 12. For example, the electric power generation section is an apparatus which generates electricity by the sunlight or wind power. Meanwhile, the electric power generation section is not limited to that apparatus which generates electricity in response the natural environment. For example, the electric power generation section may be configured as an apparatus which generates electricity by human power. Although an electric generator whose power generation energy fluctuates in response to the environment or the situation is assumed in this manner, also that electric generator whose power generation energy does not fluctuate is applicable. Therefore, as seen in FIG. 1, also AC power can be inputted to the control system 1. It is to be noted that voltages are supplied from the same electric power generation section or different electric power generation sections to the high voltage input power supply circuit 11 and the low voltage input power supply circuit 12. The voltage or voltages generated by the electric power generation section or sections are an example of a first voltage or voltages.

To the high voltage input power supply circuit 11, for example, a DC (Direct Current) voltage V10 of approximately 75 to 100 V (volts) generated by photovoltaic power generation is supplied. Alternatively, an AC (Alternating Current) voltage of approximately 100 to 250 V may be supplied to the high voltage input power supply circuit 11. The high voltage input power supply circuit 11 generates a second voltage in response to a fluctuation of the voltage V10 supplied thereto by photovoltaic power generation. For example, the voltage V10 is stepped down by the high voltage input power supply circuit 11 to generate the second voltage. The second voltage is a DC voltage, for example, within a range of 45 to 48 V.

When the voltage V10 75 V, the high voltage input power supply circuit 11 converts the voltage V10 into 45 V. However, when the voltage V10 is 100 V, the high voltage input power supply circuit 11 converts the voltage V10 into 48 V. In response to a variation of the voltage V10 within the range from 75 to 100 V, the high voltage inputs power supply circuit 11 generates the second voltage such that the second voltage changes substantially linearly within the range from 45 to 48 V. The high voltage input power supply circuit 11 outputs the generated second voltage. It is to be noted that the rate of change of the second voltage need not necessarily be linear, but a feedback circuit may be used such that the output of the high voltage input power supply circuit 11 is used as it is.

To the low voltage input power supply circuit 12, a DC voltage V11 within a range of 10 to 40 V generated, for example, by electric power generation by wind or electric power generation by human power is supplied. The low voltage input power supply circuit 12 generates a second voltage in response to a fluctuation of the voltage V11 similarly to the high voltage input power supply circuit 11. The low voltage input power supply circuit 12 steps up the voltage V11, for example, to a DC voltage within the range of 45 to 48 V in response to a change of the voltage V11 within the range from 10 V to 40V. The stepped up DC voltage is outputted from the low voltage input power supply circuit 12.

Both or one of the output voltages of the high voltage input power supply circuit 11 and the low voltage input power supply circuit 12 is inputted to the battery units BU. In FIG. 1, the DC voltage supplied to the battery units BU is denoted by V12. As described hereinabove, the voltage V12 is, for example, a DC voltage within the range from 45 to 48 V. All or some of the battery units BU are charged by the voltage V12. It is to be noted that a battery unit BU which is discharging is not charged.

A personal computer may be connectable to the control unit CU. For example, a USB (Universal Serial Bus) cable is used to connect the control unit CU and the personal computer to each other. The control unit CU may be controlled using the personal computer.

### [General Configuration of the Battery Unit]

A general configuration of a battery unit which is an example of a second apparatus is described. While description is given below taking the battery unit BUa as an example, unless otherwise specified, the battery unit BUb and the battery unit BUc have the same configuration.

The battery unit BUa includes a charger or charging circuit 41a, a discharger or discharging circuit 42a and a battery Ba. Also the other battery units BU include a charger or charging circuit, a discharger or discharging circuit and a battery. In the following description, when there is no necessity to distinguish each battery, it is referred to suitably as battery B.

The charger circuit 41a converts the voltage V12 supplied thereto from the control unit CU into a voltage applicable to the battery Ba. The battery Ba is charged based on the voltage obtained by the conversion. It is to be noted that the charger circuit 41a changes the charge rate into the battery Ba in response to a fluctuation of the voltage V12.

Electric power outputted from the battery Ba is supplied to the discharger circuit 42a. From the battery Ba, for example, a DC voltage within a range from substantially from 12 to 55 V is outputted. The DC voltage supplied from the battery Ba is converted into a DC voltage V13 by the discharger circuit 42a. The voltage V13 is a DC voltage of, for example, 48 V. The voltage V13 is outputted from the discharger circuit 42a to the control unit CU through the electric power line L2. It is to be noted that the DC voltage outputted from the battery Ba may otherwise be supplied directly to an external apparatus without by way of the discharger circuit 42a.

Each battery B may be a lithium-ion battery, an olivine-type iron phosphate lithium-ion battery, a lead battery or the like. The batteries B of the battery units BU may be those of different battery types from each other. For example, the battery Ba of the battery unit BUa and the battery Bb of the battery unit BUb are configured from a lithium-ion battery and the battery Bc of the battery unit BUc is configured from a lead battery. The number and the connection scheme of battery cells in the batteries B can be changed suitably. A plurality of battery cells may be connected in series or in parallel. Or series connections of a plurality of battery cells may be connected in parallel.

When the battery units discharge, in the case where the load is light, the highest one of the output voltages of the battery units is supplied as the voltage V13 to the electric power line L2. As the load becomes heavier, the outputs of the battery units are combined, and the combined output is supplied to the electric power line L2. The voltage V13 is supplied to the control unit CU through the electric power line L2. The voltage V13 is outputted from an output port of the control unit CU. To the control unit CU, electric power can be supplied in a distributed relationship from the battery units BU. Therefore, the burden on the individual battery units BU can be moderated.

For example, the following use form may be available. The voltage V13 outputted from the battery unit BUa is supplied to an external apparatus through the control unit CU. To the battery unit BUb, the voltage V12 is supplied from the control unit CU, and the battery Bb of the battery unit BUb is charged. The battery unit BUc is used as a redundant bower supply. For example, when the remaining capacity of the battery unit BUa drops, the battery unit to be used is changed over from the battery unit BUa to the battery unit BUc and the voltage V13 outputted from the battery unit BUc is supplied to the external apparatus. Naturally, the use form described is an example, and the use form of the control system 1 is not limited to this specific use form.

### [Internal Configuration of the Control Unit]

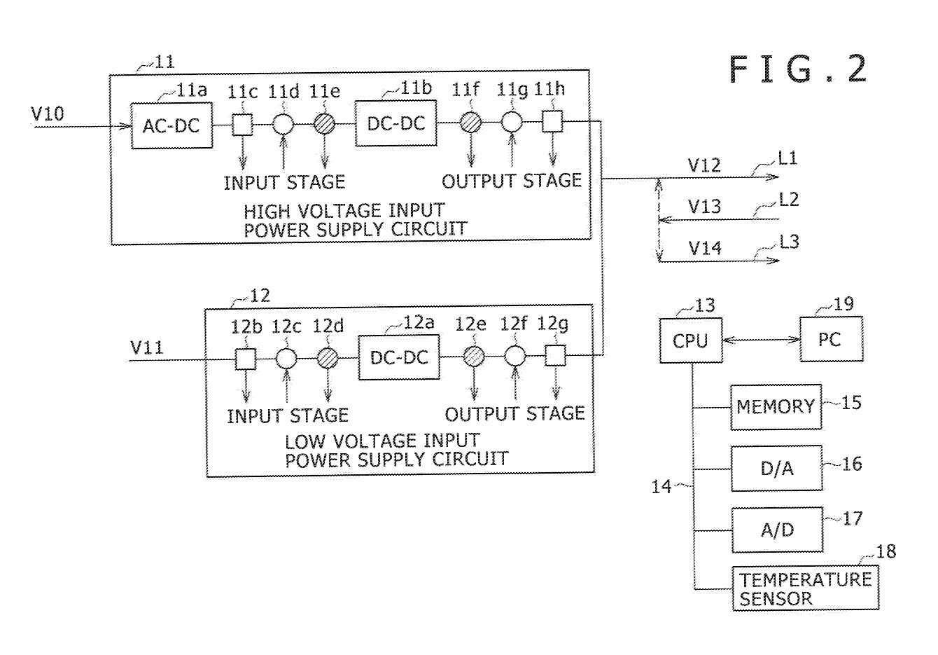

FIG. 2 shows an example of an internal configuration of the control unit CU. As described hereinabove, the control unit CU includes the high voltage input power supply circuit 11 and the low voltage input power supply circuit 12. Referring to FIG. 2, the high voltage input power supply circuit 11 includes an AC-DC converter 11a for converting an AC input to a DC output, and a DC-DC converter 11b for stepping down the voltage V10 to a DC voltage within the range from 45 to 48V. The AC-DC converter 11a and the DC-DC converter 11b may be those of known types. It is to be noted that, in the case where only a DC voltage is supplied to the high voltage input power supply circuit 11, the AC-DC converter 11a may be omitted.

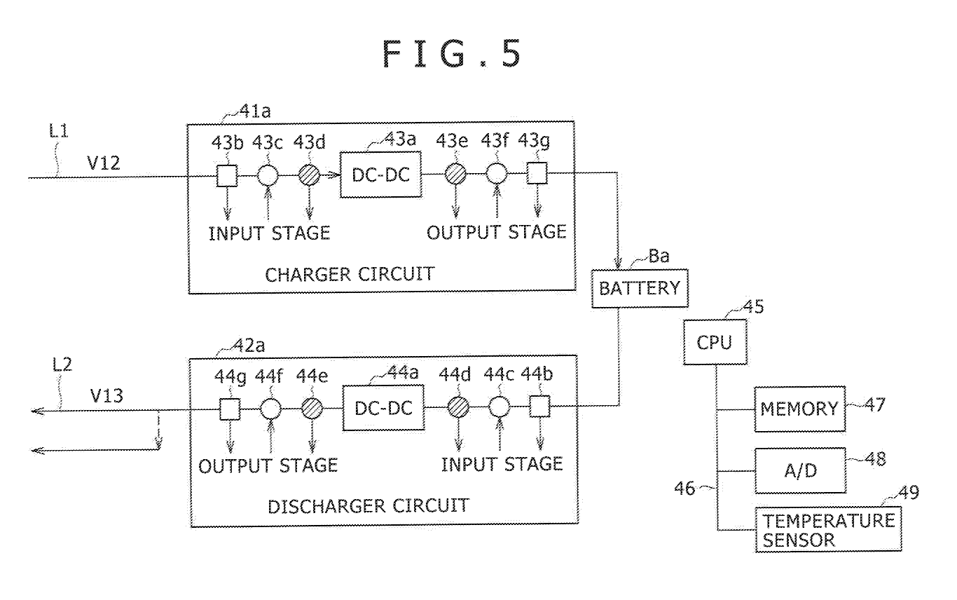

A voltage sensor, an electronic switch and a current sensor are connected to each of an input stage and an output stage of the DC-DC converter 11b. In FIG. 2 and also in FIG. 5 hereinafter described, the voltage sensor is represented by a square mark; the electronic switch by a round mark; and the current sensor by a round mark with slanting lines individually in a simplified representation. In particular, a voltage sensor 11c, an electronic switch 11d and a current sensor 11e are connected to the input stage of the DC-DC converter 11b. A current sensor 11f, an electronic switch 11g and a voltage sensor 11h are connected to the output stage of the DC-DC converter 11b. Sensor information obtained by the sensors is supplied to a CPU (Central Processing Unit) 13 hereinafter described. On/off operations of the electronic switches are controlled by the CPU 13.

The low voltage input power supply circuit 12 includes a DC-DC converter 12a for stepping up the voltage V11 to a DC voltage within the range from 45 to 48 V. A voltage sensor, an electronic switch and a current sensor are connected to each of an input stage and an output stage of the low voltage input power supply circuit 12. In particular, a voltage sensor 12b, an electronic switch 12c and a current sensor 12d are connected to the input stage of the DC-DC converter 12a. A current sensor 12e, an electronic switch 12f and a voltage sensor 12g are connected to the output stage of the DC-DC converter 12a. Sensor information obtained by the sensors is supplied to the CPU 13. On/off operations of the switches are controlled by the CPU 13.

It is to be noted that, in FIG. 2, an arrow mark extending from a sensor represents that sensor information is supplied to the CPU 13. An arrow mark extending to an electronic switch represents that the electronic switch is controlled by the CPU 13.

An output voltage of the high voltage input power supply circuit 11 is outputted through a diode. An output voltage of the low voltage input power supply circuit 12 is outputted through another diode. The output voltage of the high voltage input power supply circuit 11 and the output voltage of the low voltage input power supply circuit 12 are combined, and the combined voltage V12 is outputted to the battery unit BU through the electric power line L1. The voltage V13 supplied from the battery unit BU is supplied to the control unit CU through the electric power line L2. Then, the voltage V13 supplied to the control unit CU is supplied to the external apparatus through an electric power line L3. It is to be noted that, in FIG. 2, the voltage supplied to the external apparatus is represented as voltage V14.

The electric power line L3 may be connected to the battery units BU. By this configuration, for example, a voltage outputted from the battery unit BUa is supplied to the control unit CU through the electric power line L2. The supplied voltage is supplied to the battery unit BUb through the electric power line L3 and can charge the battery unit BUb. It is to be noted that, though not shown, power supplied to the control unit CU through the electric power line L2 may be supplied to the electric power line L1.

The control unit CU includes the CPU 13. The CPU 13 controls the components of the control unit CU. For example, the CPU 13 switches on/off the electronic switches of the high voltage input power supply circuit 11 and the low voltage input power supply circuit 12. Further, the CPU 13 supplies control signals to the battery units BU. The CPU 13 supplies to the battery units BU a control signal for turning on the power supply to the battery units BU or a control signal for instructing the battery units BU to charge or discharge. The CPU 13 can output control signals of different contents to the individual battery units BU.

The CPU 13 is connected to a memory 15, a D/A (Digital to Analog) conversion section 16, an A/D (Analog to Digital) conversion section 17 and a temperature sensor 18 through a bus 14. The bus 14 is configured, for example, from an I²C bus. The memory 15 is configured from a nonvolatile memory such as an EEPROM (Electrically Erasable and Programmable Read Only Memory). The D/A conversion section 16 converts digital signals used in various processes into analog signals.

The CPU 13 receives sensor information measured by the voltage sensors and the current sensors. The sensor information is inputted to the CPU 13 after it is converted into digital signals by the A/U conversion section 17. The temperature sensor 18 measures an environmental, temperature. For example, the temperature sensor 18 measures a temperature in the inside of the control unit CU or a temperature around the control unit CU.

The CPU 13 may have a communication function. For example, the CPU 13 and a personal computer (PC) 19 may communicate with each other. The CPU 13 may communicate not only with the personal computer but also with an apparatus connected to a network such as the Internet.

### [Power Supply System of the Control Unit]

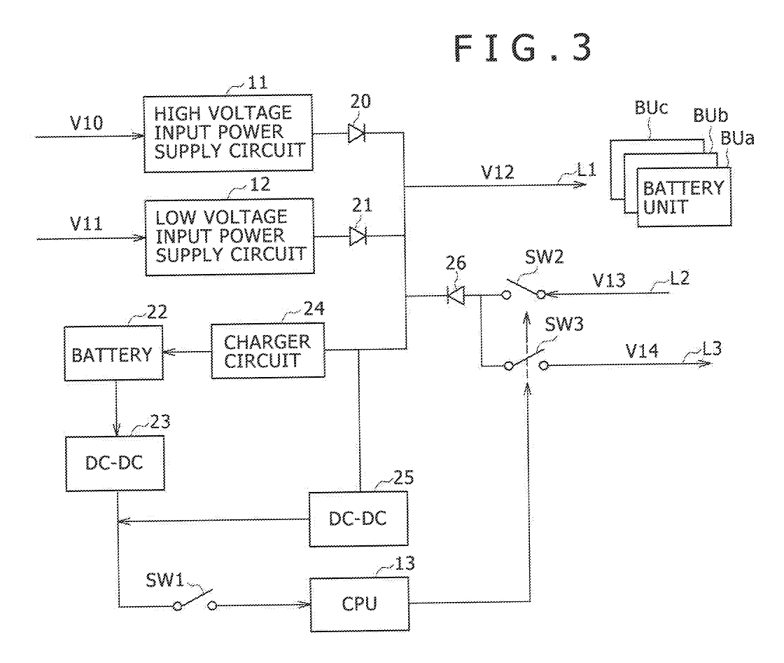

FIG. 3 principally shows an example of a configuration of the control unit CU which relates to a power supply system. A diode 20 for the backflow prevention is connected to the output stage of the high voltage input power supply circuit 11. Another diode 21 for the backflow prevention is connected to the output stage of the low voltage input power supply circuit 12. The high voltage input power supply circuit 11 and the low voltage input power supply circuit 12 are connected to each other by OR connection by the diode 20 and the diode 21. Outputs of the high voltage input power supply circuit 11 and the low voltage input power supply circuit 12 are combined and supplied to the battery unit BU. Actually, that one of the outputs of the high voltage input power supply circuit 11 and the low voltage input power supply circuit 12 which exhibits a higher voltage is supplied to the battery unit BU. However, also a situation in which the electric power from both of the nigh voltage input power supply circus 11 and the low voltage input power supply circuit 12 is supplied is entered in response to the power consumption of the battery unit BU which serves as a load.

The control unit CU includes a main switch SW1 which can be operated by a user. When the main switch SW1 is switched on, electric power is supplied to the CPU 13 to start up the control unit CU. The electric power is supplied to the CPU 13, for example, from a battery 22 built in the control unit CU. The battery 22 is a rechargeable battery such as a lithium-ion battery. A DC voltage from the battery 22 is converted into a voltage, with which the CPU 13 operates, by a DC-DC converter 23. The voltage obtained by the conversion is supplied as a power supply voltage to the CPU 13. In this manner, upon start-up of the control unit CU, the battery 22 is used. The battery 22 is controlled, for example, by the CPU 13.

The battery 22 can be charged by electric power supplied from the high voltage input power supply circuit 11 or the low voltage input, power supply circuit 12 or otherwise from the battery units BU. Electric power supplied from the battery units BU is supplied to a charger circuit 24. The charger circuit 24 includes a DC-DC converter. The voltage V13 supplied from the battery units BU is converted into a DC voltage of a predetermined level by the charger circuit 24. The DC voltage obtained by the conversion is supplied to the battery 22. The battery 22 is charged by the DC voltage supplied thereto.

It is to be noted that the CPU 13 may operate with the voltage V13 supplied thereto from the high voltage input power supply circuit 11, low voltage input power supply circuit 12 or battery units BU. The voltage V13 supplied from the battery units BU is converted into a voltage of a predetermined level by a DC-DC converter 25. The voltage obtained by the conversion is supplied as a power supply voltage to the CPU 13 so that the CPU 13 operates.

After the control unit CU is started up, if at least one of the voltages V13 and V11 is inputted, then the voltage V12 is generated. The voltage V12 is supplied to the battery units BU through the electric power line L1. At this time, the CPU 13 uses the signal line SL to communicate with the battery units BU. By this communication, the CPU 13 outputs a control signal for instructing the battery units BU to start up and discharge. Then, the CPU 13 switches on a switch SW2. The switch SW2 is configured, for example, from an FET (Field Effect Transistor). Or the switch SW2 may be configured from an IGBT (Insulated Gate Bipolar Transistor). When the switch SW2 is on, the voltage V13 is supplied from the battery units BU to the control unit CU.

A diode 26 for the backflow prevention is connected to the output side of the switch SW2. The connection of the diode 26 can prevent unstable electric power, which is supplied from a solar battery or a wind power generation source, from being supplied directly to the external apparatus. Thus, stabilized electric power supplied from the battery units BU can be supplied to the external apparatus. Naturally, a diode may be provided on the final stage of the battery units BU in order to secure the safety.

In order to supply the electric power supplied from the battery units BU to the external apparatus, the CPU 13 switches on a switch SW3. When the switch SW3 is switched on, the voltage V14 based on the voltage V13 is supplied to the external apparatus through the electric power line L3. It is to be noted that the voltage V14 may be supplied to the other battery units BU so that the batteries B of the other battery units BU are charged by the voltage V14.

### [Example of the Configuration of the High Voltage Input Power Supply Circuit]

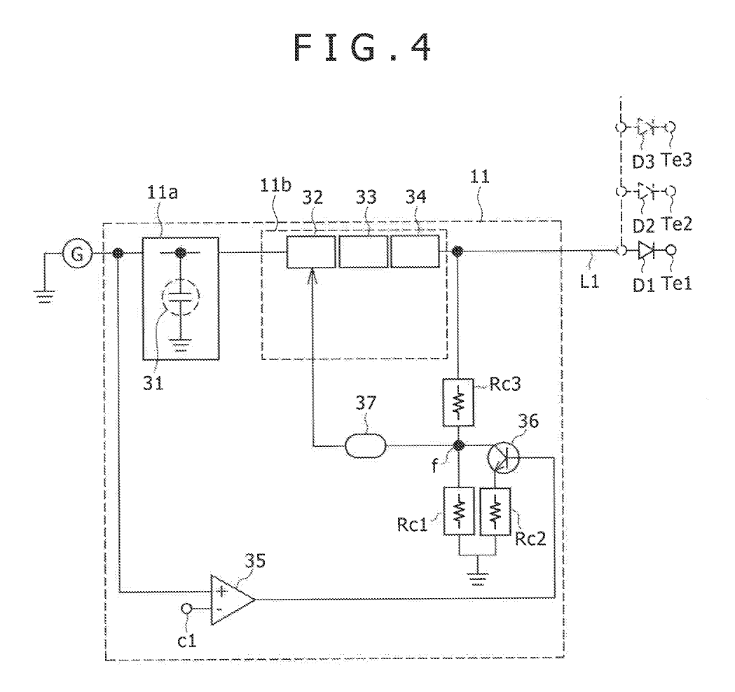

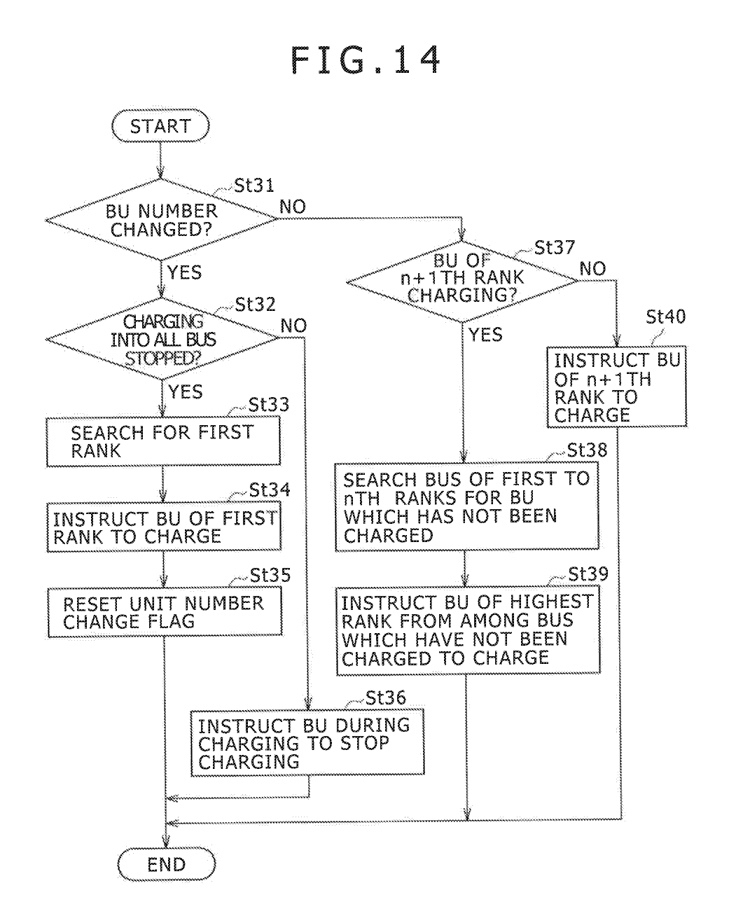

FIG. 4 shows an example of a particular configuration of the high voltage input, power supply circuit. Referring to FIG. 14, the high voltage input power supply circuit 11 includes the DC-DC converter 11b and a feedforward controlling system hereinafter described. In FIG. 4, the voltage sensor 11c, electronic switch 11d, current sensor 11e, current sensor 11f, electronic switch 11g and voltage sensor 11h as well as the diode 20 and so forth are not shown.

The low voltage input power supply circuit 12 is configured substantially similarly to the high voltage input power supply circuit 11 except that the DC-DC converter 12a is that of the step-up type.

The DC-DC converter 11b is configured from a primary side circuit 32 including, for example, a switching element, a transformer 33, and a secondary side circuit 34 including a rectification element and so forth. The DC-DC converter 11b shown in FIG. 4 is that of the current resonance type, namely, an LLC resonance converter.

The feedforward controlling system includes an operational amplifier 35, a transistor 36 and resistors Rc1, Rc2 and Rc3. An output of the feedforward controlling system is inputted to a controlling terminal provided on a driver of the primary side circuit 32 of the DC-DC converter 11b. The DC-DC converter 11b adjusts the output voltage from the high voltage input, power supply circuit 11 so that the input voltage to the controlling terminal may be fixed.

Since the high voltage input power supply circuit 11 includes the feedforward controlling system, the output voltage from the high voltage input power supply circuit 11 is adjusted so that the value thereof may become a voltage value within a range set in advance. Accordingly, the control unit CU including the high voltage input power supply circuit 11 has a function of a voltage conversion apparatus which varies the output voltage, for example, in response to a chance of the input voltage from a solar cell or the like.

As seen in FIG. 4, an output voltage is extracted from the high voltage input power supply circuit 11 through the AC-DC converter 11a including a capacitor 31, primary side circuit 32, transformer 33 and secondary side circuit 34. The AC-DC converter 11a is a power factor correction circuit disposed where the input to the control unit CU from the outside is an AC power supply.

The output from the control unit CU is sent to the battery units BU through the electric power line L1. For example, the individual battery units BUa, BUb and BUc are connected to output terminals Te1, Te2, Te3, . . . through diodes D1, D2, D3, . . . for the backflow prevention, respectively.

In the following, the feedforward controlling system provided in the high voltage input power supply circuit 11 is described.

A voltage obtained by stepping down the input voltage to the high voltage input power supply circuit 11 to kc times, where kc is approximately one several tenth or one hundredth, is inputted to the non-negated input terminal of the operational amplifier 35. Meanwhile, to the negated input terminal c1 of the operational amplifier 35, a voltage obtained by stepping down a fixed voltage Vt₀ determined in advance to kc times is inputted. The input voltage kc×Vt₀ to the negated input terminal c1 of the operational amplifier 35 is applied, for example, from the D/A conversion section 16. The value of the voltage Vt₀ is retained in a built-in memory of the D/A conversion section 16 and can be changed as occasion demands. The value of the voltage Vt₀ may otherwise be retained into the memory 15 connected to the CPU 13 through the bus 14 such that it is transferred to the D/A conversion section 16.

The output terminal of the operational amplifier 35 is connected to the base of the transistor 36, and voltage-current conversion is carried out in response to the difference between the input voltage to the non-negated input terminal and the input voltage to the negated input terminal of the operational amplifier 35 by the transistor 36.

The resistance value of the resistor Rc2 connected to the emitter of the transistor 36 is higher than the resistance value of the resistor Rc1 connected in parallel to the resistor Rc2.

It is assumed that, for example, the input voltage to the high voltage input power supply circuit 11 is sufficiently higher than the fixed voltage Vt₀ determined in advance. At this time, since the transistor 36 is in an on state, and the value of the combined resistance of the resistor Rc1 and the resistor Rc2 is lower than the resistance value of the resistor Rc1, the potential at a point f shown in FIG. 4 approaches the ground potential.

Consequently, the input voltage to the controlling terminal provided on the driver of the primary side circuit 32 and connected to the point f through a photo coupler 37 drops. The DC-DC converter 11b which detects the drop of the input voltage to the controlling terminal steps up the output voltage from the high voltage input power supply circuit 11 so that the input voltage to the controlling terminal may be fixed.

It is assumed now that, for example, the terminal voltage of the solar cell connected to the control unit CU drops conversely and the input voltage to the high voltage input power supply circuit 11 approaches the fixed voltage Vt₀ determined advance.

As the input voltage to the high voltage input power supply circuit 11 drops, the state of the transistor 36 approaches an off state from an on state. As the state of the transistor 36 approaches an off state from an on state, current becomes less likely to flow to the resistor Rc1 and the resistor Rc2, and the potential at the point f shown in FIG. 4 rises.

Consequently, the input voltage to the controlling terminal, provided on the driver of the primary side circuit 32 is brought out of a state in which it is kept fixed. Therefore, the DC-DC converter 11b steps down the output voltage from the high voltage input power supply circuit 11 so that the input voltage to the controlling terminal may be fixed.

In other words, in the case where the input voltage is sufficiently higher than the fixed voltage Vt₀ determined advance, the high voltage input power supply circuit 11 steps up the output voltage. On the other hand, if the terminal voltage of the solar cell drops and the input voltage approaches the fixed voltage Vt₀ determined in advance, then the high voltage input power supply circuit 11 steps down the output voltage. In this manner, the control unit CU including the high voltage input bower supply circuit 11 dynamically changes the output voltage in response to the magnitude of the input voltage.

Furthermore, as hereinafter described, the high voltage input power supply circuit 11 dynamically changes the output voltage also in response to a change of the voltage required on the output side of the control unit CU.

For example, it is assumed that the number of those battery units BU which are electrically connected to the control unit CU increases during electric generation of the solar cell. In other words, it is assumed that the load as viewed from she solar cell increases during electric generation of the solar cell.

In, this instance, a battery unit BU is electrically connected additionally to the control unit CU, and consequently, the terminal voltage of the solar cell connected to the control unit CU drops. Then, when the input voltage to the high voltage input power supply circuit 11 drops, the state of the transistor 36 approaches an off state from an on state, and the output voltage from the high voltage input power supply circuit 11 is stepped down.

On the other hand, if it is assumed that the number of those battery units BU which are electrically connected to the control unit CU decreases during electric generation of the solar cell, then the load as viewed from the solar cell decreases. Consequently, the terminal voltage of the solar cell connected to the control unit CU rises. If the input voltage to the high voltage input power supply circuit 11 becomes sufficiently higher than the fixed voltage Vt₀ determined in advance, then the input voltage to the controlling terminal provided on the driver of the primary side circuit 32 drops. Consequently, the output voltage from the high voltage input power supply circuit 11 is stepped up.

It is to be noted that the resistance values of the resistors Rc1, Rc2 and Rc3 are selected suitably such that the value of the output voltage of the high voltage input power supply circuit 11 may be included in a range set in advance. In other words, the upper limit to the output voltage from the high voltage input power supply circuit 11 is determined by the resistance values of the resistors Rc1, and Rc2. The transistor 36 is disposed so that, when the input voltage to the high voltage input power supply circuit 11 is higher than the predetermined value, the value of the output voltage from the high voltage input power supply circuit 11 may not exceed the voltage value of the upper limit set in advance.

On the other hand, the lower limit to the output voltage from the high voltage input power supply circuit 11 is determined by the input voltage to the non-negated input terminal of an operational amplifier of a feedforward controlling system of the charger circuit 41a as hereinafter described.

### [Internal Configuration of the Battery Unit]

FIG. 5 shows an example of an internal configuration of the battery units BU. Here, description is given taking the battery unit BUa as an example. Unless otherwise specified, the battery unit hub and the battery unit BUc have a configuration similar to that of the battery unit BUa.

Referring to FIG. 5, the battery unit BUa includes a charger circuit 41a, a discharger circuit 42a and a battery Ba. The voltage V12 is supplied from the control unit CU to the charger circuit 41a. The voltage V13 which is an output from the battery unit BUa is supplied to the control unit CU through the discharger circuit 42a. The voltage V13 may otherwise be supplied directly to the external apparatus from the discharger circuit 42a.

The charger circuit 41a includes a DC-DC converter 43a. The voltage V12 inputted to the charger circuit 41a is converted into a predetermined voltage by the DC-DC converter 43a. The predetermined voltage obtained by the conversion is supplied to the battery Ba to charge the battery Ba. The predetermined voltage differs depending upon the type and so forth of the battery Ba. To the input stage of the DC-DC converter 43a, a voltage sensor 43b, an electronic switch 43c and a current sensor 43d are connected. To the output stage of the DC-DC converter 43a, a current sensor 43e, an electronic switch 43f and a voltage sensor 43a are connected.

The discharger circuit 42a includes a DC-DC converter 44a. The DC voltage supplied from the battery Ba to the discharger circuit 42a is converted into the voltage V13 by the DC-DC converter 44a. The voltage V13 obtained by the conversion is outputted from the discharger circuit 42a. To the input stage of the DC-DC converter 44a, a voltage sensor 44b, an electronic switch 44c and a current sensor 44d are connected. To the output stage of the DC-DC converter 44a, a current sensor 44e, an electronic switch 44f and a voltage sensor 44g are connected.

The battery unit BUa includes a CPU 45. The CPU 45 controls the components of the battery unit BU. For example, the CPU 45 controls on/off operations of the electronic switches. The CPU 45 may carry out processes for assuring the safety of the battery B such as an overcharge preventing function and an excessive current preventing function. The CPU 45 is connected to a bus 46. The bus 46 may be, for example, an I²C. bus.

To the bus 46, a memory 47, an A/D conversion section 48 and a temperature sensor 49 are connected. The memory 47 is a rewritable nonvolatile memory such as, for example, an EEPROM. The A/D conversion section 48 converts analog sensor information obtained by the voltage sensors and the current sensors into digital information. The sensor information converted into digital signals by the A/D conversion section 48 is supplied to the CPU 45. The temperature sensor 49 measures the temperature at a predetermined place in the battery unit BU. Particularly, the temperature sensor 49 measures, for example, the temperature of the periphery of a circuit board on which the CPU 45 is mounted, the temperature of the charger circuit 41a and the discharger circuit 42a and the temperature of the battery Ba.

### [Power Supply System of the Battery Unit]

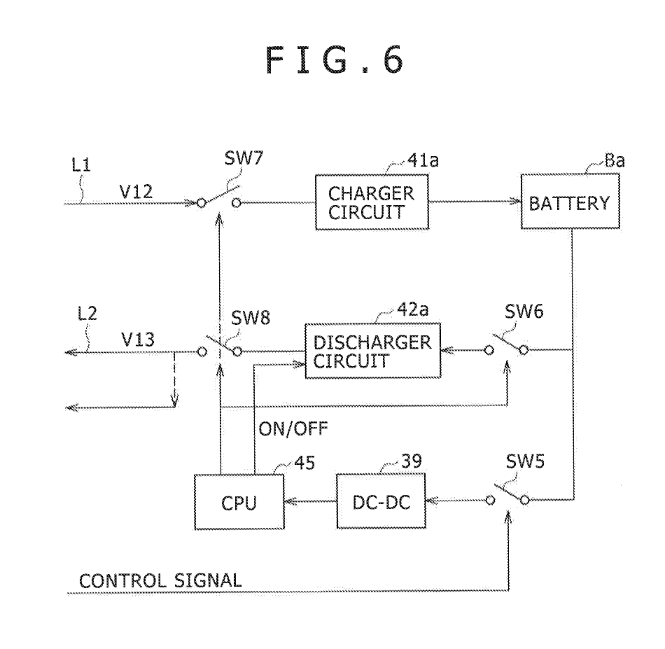

FIG. 6 shows an example of a configuration of the battery unit BUa principally relating to a power supply system. Referring to FIG. 6, the battery unit BUa does not include a main switch. A switch SW5 and a DC-DC converter 39 are connected between the battery Ba and the CPU 45. Another switch SW6 is connected between the battery Ba and the discharger circuit 42a. A further switch SW7 is connected to the input stage of the charger circuit 41a. A still further switch. SW8 is connected to the output stage of the discharger circuit 42a. The switches SW are configured, for example, from an FET.

The battery unit BUa, is started up, for example, by a control signal from the control unit CU. A control signal, for example, of the high level is normally supplied from the control unit CU to the battery unit BUa through a predetermined signal line. Therefore, only by connecting a port of the battery unit BUa to the predetermined signal line, the control signal of the high level is supplied to the switch SW5 making the switch SW5 in an on state to start so the battery unit BUa. When the switch SW5 is on, a DC voltage from the battery Ba is supplied to the DC-DC converter 39. A power supply voltage for operating the CPU 45 is generated by the DC-DC converter 39. The generated power supply voltage is supplied to the CPU 45 to operate the CPU 45.

The CPU 45 executes control in accordance with an instruction of the control unit CU. For example, a control signal for the instruction to charge is supplied from the control unit CU to the CPU 45. In response to the instruction to charge, the CPU 45 switches off the switch SW6 and the switch SW8 and then switches on the switch SW7. When the switch SW7 is on, the voltage V12 supplied from the control unit CU is supplied to the charger circuit 41a. The voltage V12 is converted into a predetermined voltage by the charger circuit 41a, and the battery Ba is charged by the predetermined voltage obtained by the conversion it is to be noted that the charging method into the battery B can be changed suitably in response to the type of the battery B.

For example, a control signal for the instruction to discharge is supplied from the control unit CU to the CPU 45. In response to the instruction to discharge, the CPU 45 switches off the switch SW7 and switches on the switches SW6 and SW8. For example, the switch SW8 is switched on after a fixed interval of time after the switch SW6 is switched on. When the switch SW6 is on, the DC voltage from the battery Ba is supplied to the discharger circuit 42a. The DC voltage from the battery Ba is converted into the voltage V173 by the discharger circuit 42a. The voltage V13 obtained by the conversion is supplied to the control unit CU through the switch SW8. It is to be noted that, though not shown, a diode may be added to a succeeding stage to the switch SW8 in order to prevent the output of the switch SW8 from interfering with the output from a different one of the battery units BU.

It is to be noted that the discharger circuit 42a can be changed over between on and off by control of the CPU 45. In this instance, an ON/OFF signal line extending from the CPU 45 to the discharger circuit 42a is used. For example, a switch SW not shown is provided on the output side of the switch SW6. The switch. SW in this instance is hereinafter referred to as switch SW10 taking the convenience in description into consideration. The switch SW10 carries out changeover between a first path which passes the discharger circuit 42a and a second path which does not pass the discharger circuit 42a.

In order to turn on the discharger circuit 42a, the CPU 45 connects the switch SW10 to the first path. Consequently, an output from the switch SW6 is supplied to the switch SW8 through the discharger circuit 42a. In order to turn off the discharger circuit 42a, the CPU 45 connects the switch SW10 to the second path. Consequently, the output from the switch SW6 is supplied directly to the switch SW8 without by way of the discharger circuit 42a.

### [Example of the Configuration of the Charger Circuit]

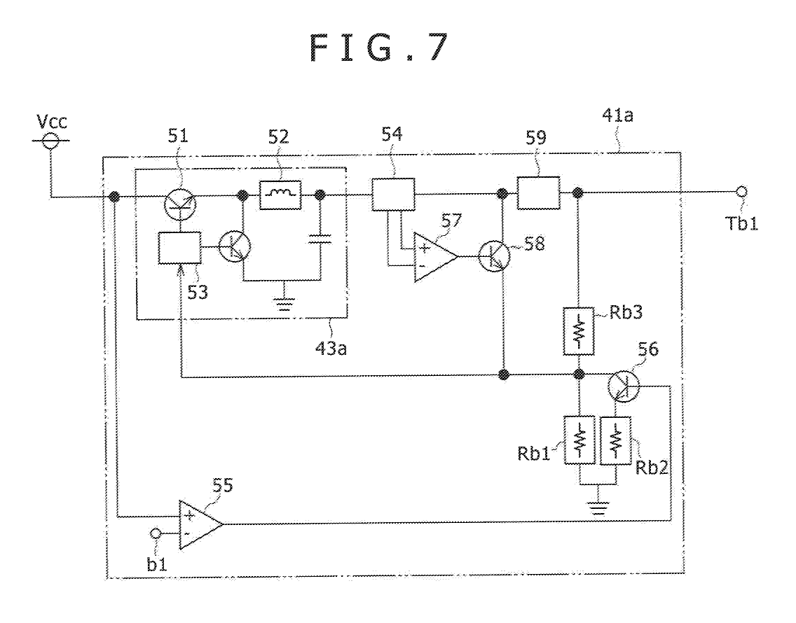

FIG. 7 shows an example of a particular configuration of the charger circuit of the battery unit. Referring to FIG. 7, the charger circuit 41a includes a DC-DC converter 43a, and a feedforward controlling system and a feedback controlling system hereinafter described. It is to be noted that, in FIG. 7, the voltage sensor 43b, electronic switch 43c, current sensor 43d, current sensor 43e, electronic switch 43f, voltage sensor 43g, switch SW7 and so forth are not shown.

Also the charger circuits of the battery units BU have a configuration substantially similar to that of the charger circuit 41a shown in FIG. 7.

The DC-DC converter 43a is configured, for example, from a transistor 51, a coil 52, a controlling IC (Integrated Circuit) 53 and so forth. The transistor 51 is controlled by the controlling IC 53.

The feedforward controlling system includes an operational amplifier 55, a transistor 56, and resistors Rb1, Rb2 and Rb3 similarly to the high voltage input power supply circuit 11. An output of the feedforward controlling system is inputted, for example, to a controlling terminal provided on the controlling IC 53 of the DC-DC converter 43a. The controlling IC 53 in the DC-DC converter 43a adjusts the output voltage from the charger circuit 41a so that the input voltage to the controlling terminal may be fixed.

In other words, the feedforward controlling system provided in the charger circuit 41a acts similarly to the feedforward controlling system provided in the high voltage input power supply circuit 11.

Since the charger circuit 41a includes the feedforward controlling system, the output voltage from the charger circuit 41a is adjusted so that the value thereof may become a voltage value within a range set in advance. Since the value of the output voltage from the charger circuit is adjusted to a voltage value within the range set in advance, the charging current to the batteries B electrically connected to the control unit CU is adjusted in response to a change of the input voltage from the high voltage input power supply circuit 11. Accordingly, the battery units BU which include the charger circuit have a function of a charging apparatus which changes the charge rate to the batteries B.

Since the charge rate to the batteries B electrically connected to the control unit CU is changed, the value of the input voltage to the charger circuits of the battery units BU, or in other words, the value of the output voltage of the high voltage input power supply circuit 11 or the low voltage input power supply circuit 12, is adjusted so as to become a voltage value within the range set in advance.

The input to the charger circuit 41a is an output, for example, from the high voltage input power supply circuit 11 or the low voltage input power supply circuit 12 of the control unit CU described hereinabove. Accordingly, one of the output terminals Te1, Te2, Te3, . . . shown in FIG. 4 and the input terminal of the charger circuit 41a are connected to each other.

As seen in FIG. 7, an output voltage from the charger circuit 41a is extracted through the DC-DC converter 43a, a current sensor 54 and a filter 59. The battery Ba is connected to a terminal Tb1 of the charger circuit 41a. In other words, the output from the charger circuit 41a is used as an input to the battery Ba.

As hereinafter described, the value of the output voltage from each charger circuit is adjusted so as to become a voltage value within the range set in advance in response to the type of the battery connected to the charger circuit. The range of the output voltage from each charger circuit is adjusted by suitably selecting the resistance value of the resistors Rb1, Rb2 and Rb3.

Since the range of the output voltage from each charger circuit is determined individually in response to the type of the battery connected to the charger circuit, the type of the batteries B provided in the battery units BU is not limited specifically. This is because the resistance values of the resistors Rb1, Rb2 and Rb3 in the charger circuits may be suitably selected in response to the type of the batteries B connected thereto.

It is to be noted that, while the configuration wherein the output of the feedforward controlling system is inputted to the controlling terminal of the controlling IC 53 is shown in FIG. 7, the CPU 45 of the battery units BU may supply an input to the controlling terminal of the controlling IC 53. For example, the CPU 45 of the battery unit BU may acquire information relating to the input voltage to the battery unit BU from the CPU 13 of the control unit CU through the signal line SL. The CPU 13 of the control unit CU can acquire information relating to the input voltage to the battery unit BU from a result of measurement of the voltage sensor 11h or the voltage sensor 12g.

In the following, the feedforward controlling system provided in the charger circuit 41a is described.

The input to the non-negated input terminal of the operational amplifier 55 is a voltage obtained by stepping down the input voltage to the charger circuit 41a to kb times, where kb is approximately one several tenth to one hundredth. Meanwhile, the input to the negated input, terminal b1 of the operational amplifier 55 is a voltage obtained by stepping down a voltage Vb, which is to be set as a lower limit to the output voltage from the high voltage input power supply circuit 11 or the low voltage input power supply circuit 12, to kb times. The input voltage kb×Vb to the negated input terminal b1 of the operational amplifier 55 is applied, for example, from the CPU 45.

Accordingly, the feedforward controlling system provided in the charger circuit 41a steps up the output voltage from the charger circuit 41a when the input voltage to the charger circuit 41a is sufficiently higher than the fixed volt age Vb determined in advance. Then, when the input voltage to the charger circuit 41a approaches the fixed voltage Vb determined in advance, the feedforward controlling system steps down the output voltage from the charger circuit 41a.

The transistor 56 is disposed so that, when the input voltage to the charger circuit 41a is higher than the predetermined value, the value of the output voltage from the charger circuit 41a may not exceed an upper limit set in advance similarly to the transistor 36 described hereinabove with reference to FIG. 4. It is to be noted that the range of the value of the output voltage from the charger circuit 41a depends upon the combination of the resistance values of the resistors Rb1, Rb2 and Rb3. Therefore, the resistance values of the resistors Rb1, Rb2 and Rb3 are adjusted in response to the type of the batteries B connected to the charger circuits.

Further, the charger circuit 41a includes also the feedback controlling system as described hereinabove. The feedback controlling system is configured, for example, from a current sensor 54, an operational amplifier 57, a transistor 58 and so forth.

If the current amount supplied to the battery Ba exceeds a prescribed value set in advance, then the output voltage from the charger circuit 41a is stepped down by the feedback controlling system, and the current amount supplied to the battery Ba is limited. The degree of the limitation to the current amount to be supplied to the battery Ba is determined in accordance with a rated value of the battery B connected to each charger circuit.

If the output voltage from the charger circuit 41a is stepped down by the feedforward controlling system or the feedback controlling system, then the current amount to be supplied to the battery Ba is limited. When the current amount supplied to the battery Ba is limited, as a result, charging into the battery is connected to the charger circuit 41a is decelerated.

Now, in order to facilitate understandings of the embodiment of the present disclosure, a control method is described taking the MPPT control and control by the voltage tracking method as an example,

### [MPPT Control]

First, an outline of the MPPT control is described below.

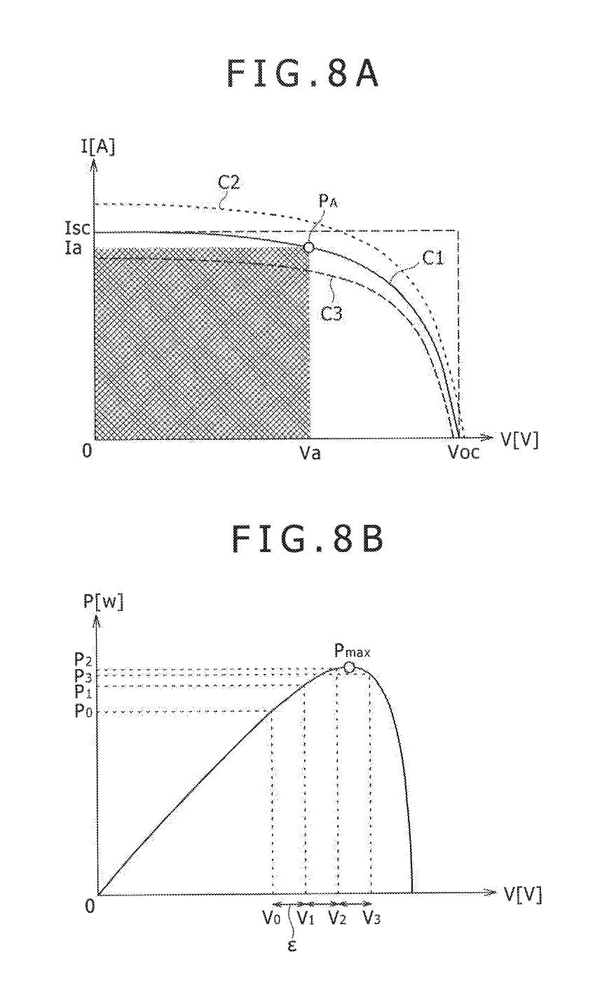

FIG. 8A is a graph illustrating a voltage-current characteristic of a solar cell. In FIG. 8A, the axis of ordinate represents the terminal current of the solar cell and the axis of abscissa represents the terminal voltage of the solar cell. Further, in FIG. 8A, Isc represents an output current value when the terminals of the solar cell are short-circuited while light is irradiated upon the solar cell, and Voc represents an output voltage when the terminals of the solar cell are open while light is irradiated upon the solar cell. The current Isc and the voltage Voc are called short-circuit current and open-circuit voltage, respectively.

As seen in FIG. 8A, when light is irradiated upon the solar cell, the terminal current of the solar cell indicates a maximum value when the terminals of the solar cell are short-circuited. At this time, the terminal voltage of the soar cell is almost 0 V. On the other hand, when light is irradiated upon the solar cell, the terminal voltage of the solar cell exhibits a maximum value when the terminals of the solar cell are open. At this time, the terminal current of the solar cell is substantially 0 A.

It is assumed now that the graph indicative of a voltage-current characteristic of the solar cell is represented by a curve C1 shown in FIG. 8A. Here, if a load is connected to the solar cell, then the voltage and current to be extracted from the solar cell depend upon the power consumption required by the load connected to the solar cell. A point on the curve C1 represented by a set of the terminal voltage and the terminal current of the solar cell at this time is called operating point of the solar cell. It is to be noted that FIG. 8A schematically indicates the position of the operating point but does not indicate the position of an actual operating point. This similarly applies also to an operating point appearing on any other figure of the present disclosure.

If the operating point is changed on the curve representative of a voltage-current characteristic of the solar cell, then a set of a terminal voltage Va and terminal current Ia with which the product of the terminal voltage and the terminal current, namely, the generated electric power, exhibits a maximum value, is found. The point represented by the set of the terminal voltage Va and the terminal current Ia with which the electric power obtained by the solar, cell exhibits a maximum value is called optimum operating point of the solar cell.

When the graph indicative of a voltage-current characteristic of the solar cell is represented by the curve C1 illustrated in FIG. 8A, the maximum electric power obtained from the solar cell is determined by the product of the terminal voltage Va and the terminal current Ia which provide the optimum operating point. In other words, when the graph indicating a voltage-current characteristic of the solar cell is represented by the curve C1 illustrated in FIG. 8A, the maximum electric power obtained from the solar cell is represented by the area of a shadowed region in FIG. 8A, namely by Va×Ia. It is to be noted that the amount obtained by dividing Va×Ia by Voc×Isc is a fill factor.

The optimum operating point varies depending upon the electric power required by the load connected to the solar cell, and the point P_{A} representative of the operating point moves on the curve C1 as the electric power required by the load connected to the solar cell varies. When the electric power amount required by the load is small, the current to be supplied to the load may be lower than the terminal current at the optimum operating point. Therefore, the value of the terminal voltage of the solar cell at this time is higher than the voltage value at the optimum operating point. On the other hand, when the electric power amount required by the load is greater than the electric power amount which can be supplied at the optimum operating point, the electric power amount exceeds the electric power which can be supplied at the illumination intensity at this point of time. Therefore, it is considered that the terminal voltage of the solar cell drops toward 0 V.

Curves C2 and C3 shown in FIG. 8A indicate, for example, voltage-current characteristics of the solar cell when the illumination intensity upon the solar cell varies. For example, the curve C2 shown in FIG. 8A corresponds to the voltage-current characteristic in the case where the illumination intensity upon the solar cell increases, and the curve C3 shown in FIG. 8A corresponds to the voltage-current characteristic in the case where the illumination intensity upon the solar cell decreases.

For example, if the illumination intensity upon the solar cell increases and the curve representative of the voltage-current characteristic of the solar cell, changes from the curve C1 to the curve C2, then also the optimum operating point varies in response to the increase of the illumination intensity upon the solar cell. It is to be noted that the optimum operating point at this time moves from a point on the curve C1 to another point on the curve C2.

The MPPT control is nothing but to determine an optimum operating point with respect to a variation of a curve representative of a voltage-current characteristic of the solar cell, and control the terminal voltage or terminal current of the solar cell, so that electro power obtained from the solar cell may be maximized.

FIG. 8B is a graph, namely, a P-V curve, representative of a relationship between the terminal voltage of the solar cell and the generated electric power of the solar cell in the case where a voltage-current characteristic of the solar cell is represented by a certain curve.

If it is assumed that the generated electric bower of the solar cell assumes a maximum value Pmax at the terminal voltage at which the maximum operating point is provided as seen in FIG. 8B, then the terminal voltage which provides the maximum operating point can be determined by a method called mountain climbing method. A series of steps described below is usually executed by a CPU or the like of a power conditioner connected between the solar cell and the power system.

For example, the initial value of the voltage inputted from the solar cell is set to V₀ and the generated electric power P₀ at this time is calculated first. Then, the voltage to be inputted from the solar cell is incremented by ε, which is greater than 0, namely, ε>0, to determine the voltage V₁ as represented by V₁=V₀+ε. Then, the generated electric power P₁ when the voltage inputted from the solar cell is V₁ is calculated. Then, the generated electric powers P₀ and P₁ are compared with each other, and if P₁>P₀, then the voltage to be inputted from the solar cell is incremented by ε as represented by V₂=V₁+ε. Then, the generated electric power P₂ when the voltage inputted from the solar cell is V₂ is calculated. Then, the resulting generated electric power P₂ is compared with the formerly generated electric power P₁. Then if P₂>P₁, then the voltage to be inputted from the solar cell is incremented by ε as represented by V₃=V₂+ε. Then, the generated electric power P₃ when the voltage inputted from the solar cell is V₃ is calculated.

Here, if P₃<P₂, then the terminal voltage which provides the maximum operating point exists between the voltages V₂ and V₃. By adjusting the magnitude of ε in this manner, the terminal voltage which provides the maximum operating point, can be determined with an arbitrary degree of accuracy. A bisection method algorithm may be applied to the procedure described above. It is to be noted that, if the P-V curve has two or more peaks in such a case that a shade appears locally on the light irradiation face of the solar cell, then a simple mountain climbing method cannot cope with this. Therefore, the control program requires some scheme.

According to the MPPT control, since the terminal voltage can be adjusted such that the load as viewed from the solar cell is always in an optimum state, maximum electric power can be extracted from the solar cell in different weather conditions. On the other hand, analog/digital conversion (A/D conversion) is required for calculation of the terminal voltage which provides the maximum operating point and besides multiplication is included in the calculation. Therefore, time is required for the control. Consequently, the MPPT control cannot sometimes respond to a sudden change of the illumination intensity upon the solar cell in such a case that the sky suddenly becomes cloudy and the illumination intensity upon the solar cell changes suddenly,

### [Control by the Voltage Tracking Method]

Here, if the curves C1 to C3 shown in FIG. 8A are compared with each other, then the change of the open voltage Voc with respect to the change of the illumination intensity upon the solar cell, which may be considered a change of a curve representative of a voltage-current characteristic, is smaller than the change of the short-circuit current Isc. Further, all solar cells indicate voltage-current characteristics similar to each other, and it is known that, in the case of a crystal silicon solar cell, the terminal voltage which provides the maximum operating point is found around approximately 80% of the open voltage. Accordingly, it is estimated that, if a suitable voltage value is set as the terminal voltage of the solar cell and the output current of a converter is adjusted so that the terminal voltage of the solar cell becomes equal to the set voltage value, then electric power can be extracted efficiently from the solar cell. Such control by current limitation as just described is called voltage tracking method.

In the following, an outline of the control by the voltage tracking method is described. It is assumed that, as a premise, a switching element is disposed between the solar cell and the power conditioner and a voltage measuring instrument is disposed between the solar cell and the switching element. Also it is assumed that the solar cell is in a state in which light is irradiated thereon.

First, the switching element is switched off, and then when predetermined time elapses, the terminal voltage of the solar cell is measured by the voltage measuring instrument. The reason why the lapse of the predetermined time is waited before measurement of the terminal voltage of the solar cell after the switching off of the switching element is that it is intended to wait that the terminal voltage of the solar cell is stabilized. The terminal voltage at this time is the open voltage Voc.

Then, the voltage value of, for example, 80% of the open voltage Voc obtained by the measurement is calculated as a target voltage value, and the target voltage value is temporarily retained into a memory or the like. Then, the switching element is switched on to start energization of the converter in the power conditioner. At this time, the output current of the converter is adjusted so that the terminal voltage of the solar cell becomes equal to the target voltage value. The sequence of processes described above is executed after every arbitrary interval of time.

The control by the voltage tracking method is high in loss of the electric power obtained by the solar well in comparison with the MPPT control. However, since the control by the voltage tracking method can be implemented by a simple circuit and is lower in cost, the power conditioner including the converter can be configured at a comparatively low cost.

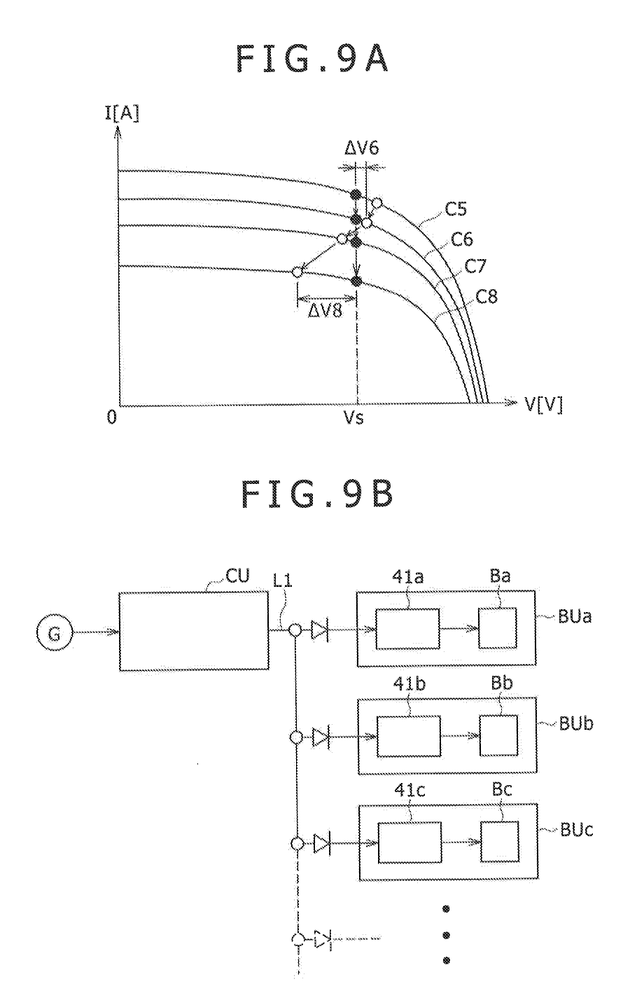

FIG. 9A illustrates a change of the operating point with respect to a change of a curve representative of a voltage-current characteristic of the solar cell. In FIG. 9A, the axis of ordinate represents the terminal current of the solar cell, and the axis of abscissa, represents the terminal voltage of the solar cell. Further, a blank round mark in FIG. 9A represents the operating point when the MPPT control is carried out and a solid round mark in FIG. 9A represents the operating point when control by the voltage tracking method is carried out.

It is assumed now that the curve representative of a voltage-current characteristic, of the solar cell is a curve C5. Then, if it is assumed that, when the illumination intensity upon the solar cell changes, the curve representative of the voltage-current characteristic of the solar cell successively changes from the curve C5 to a curve C8. Also the operating points according to the control methods change in response to the change of the curve representative of the voltage-current characteristic of the solar cell. It is to be noted that, since the change of the open voltage Voc with respect to the change of the illumination intensity upon the solar cell is small, in FIG. 9A, the target voltage value when control by the voltage tracking method is carried out is regarded as a substantially fixed value Vs.

As can be seen from FIG. 9A, when the curve representative of the voltage-current characteristic of the solar cell is a curve C6, the degree of the deviation the operating point of the MPPT control and the operating point of the control by the voltage, tracking method is low. Therefore, it is considered that, when the curve representative of the voltage-current characteristic of the solar cell is the curve C6, there is no significant difference in generated electric power obtained by the solar cell between the two different controls.

On the other hand, if the curve representative of the voltage-current characteristic of the solar cell is the curve C8, then the degree of the deviation between the operating point of the MPPT control and the operating point of the control by the voltage tracking method is high. For example, if the differences ΔV6 and ΔV8 between the terminal voltage when the MPPT control is applied and the terminal voltage when the control by the voltage tracking method is applied, respectively, are compared with each other as seen in FIG. 9A, then ΔV6<ΔV8. Therefore, when the curve representative of the voltage-current characteristic of the solar cell is the curve C8, the difference between the generated electric power obtained from the solar cell when the MPPT control is applied and the generated electric power obtained from the solar cell when the control by the voltage tracking method is applied is great.

### [Cooperation Control of the Control Unit and the Battery Unit]

Now, an outline of cooperation control of the control unit and the battery unit is described. In the following description, control by cooperation or interlocking of the control unit and the battery unit is suitably referred to as cooperation control.

FIG. 9B shows an example of a configuration of a control system wherein cooperation control by a control unit and a plurality of battery units is carried out.

Referring to FIG. 9B, for example, one or a plurality of battery units BU each including a set of a charger circuit and a battery are connected to the control unit CU. The one or plural, battery units BU are connected in parallel to the electric power line L1 as shown in FIG. 9B. It is to be noted that, while only one control unit CU is shown in FIG. 9B, also in the case where the control system includes a plurality of control units CU, one or a plurality of control units CU are connected in parallel to the electric, power line L1.

Generally, if it is tried to use electric power obtained by a solar cell to charge one battery, then the MPPT control or the control by the voltage tracking method described above is executed by a power conditioner interposed between the solar cell, and the battery. Although the one battery may be configured from a plurality of batteries which operate in an integrated manner, usually the batteries are those of the single type. In other words, it is assumed that the MPPT control or the control by the voltage tracking method described above is executed by a single power conditioner connected between a solar cell and one battery. Further, the number and configuration, which is a connection scheme such as parallel connection or series connection, of batteries which make a target of charging do not change but are fixed generally during charging.

In the meantime, in the cooperation control, the control unit CU and the plural battery units BUa, BUb, BUc, . . . carry out autonomous control so that the output voltage of the control unit CU and the voltage required by the battery units BU are balanced well with each other. As described hereinabove, the batteries B included in the battery units BUa, BUb, BUc, . . . may be of any types. In other words, the control unit CU according to the present disclosure can carry out cooperation control, for a plurality of types of batteries B.

Further, in the configuration example shown in FIG. 9B, the individual battery units BU can be connected or disconnected arbitrarily, and also the number of battery units BU connected to the control unit CU is changeable during electric generation of the solar cell. In the configuration example shown in FIG. 9B, the load as viewed from the solar cell is variable during electric generation of the solar cell. However, the cooperation control can cope not only with a variation of the illumination intensity on the solar cell but also with a variation, of the load as viewed from the solar cell during electric generation of the solar cell. This is one of significant characteristics which are not achieved by configurations in related arts.

It is possible to construct a control system which dynamically changes the charge rate in response to the supplying capacity from the control unit CU by connecting the control unit CU and the battery units BU described above to each other. In the following, an example of the cooperation control is described. It is to be noted that, although, in the following description, a control system wherein, in an initial state, one battery unit hie is connected to the control unit CU is taken as an example, the cooperation control applies similarly also where a plurality of battery units BU are connected to the control unit CU.

It is assumed that, for example, the solar cell is connected to the input side of the control unit CU and the battery unit BUa is connected to the output side of the control unit CU. Also it is assumed that the upper limit to the output voltage of the solar cell is 100 V and the lower limit, to the output voltage of the solar cell is desired to be suppressed to 75 V. In other words, it is assumed that the voltage Vt₀ is set to Vt₀=75 V and the input voltage to the negated input terminal of the operational amplifier 35 is kc×75 V.

Further, it is assumed that the upper limit and the lower limit to the output voltage from the control unit CU are set, for example, to 48 V and 45 V, respectively. In other words, it is assumed that the voltage Vb is set to Vb=45 V and the input voltage to the negated input terminal of the operational amplifier 55 is kb×45 V. It is to be noted that the value of 48 V which is the upper limit to the output terminal from the control unit CU is adjusted by suitably selecting the resistors Rc1 and Rc2 in the high voltage input power supply circuit 11. In other words, it is assumed that the target voltage value of the output from the control unit CU is set to 48 V.

Further, it is assumed that the upper limit and the lower limit to the output voltage from the charger circuit 41a of the battery unit BUa are set, for example, to 42 V and 28 V, respectively. Accordingly, the resistors Rb1, Rb2 and Rb3 in the charger circuit 41a are selected so that the upper limit and the lower limit to the output voltage from the charger circuit 41a may become 42 V and 28 V, respectively.

It is to be noted that a state in which the input voltage to the charger circuit 41a is the upper limit voltage corresponds to a stare in which the charge rate into the battery Ba is 100% whereas another state in which the input voltage to the charger circuit 41a is the lower limit voltage corresponds to a state in which the charge rate is 0%. In particular, the state in which the input voltage to the charger circuit 41a is 48 V corresponds to the state in which the charge rate into the battery Ba is 100%, and the state in which the input voltage to the charger circuit 41a is 45 V corresponds to the state in which the charge rate into the battery Ba is 0%. In response to the variation within the range of the input voltage from 45 to 48 V the charge rate is set within the range of 0 to 100%.

It is to be noted that charge rate control into the battery may be carried out in parallel to and separately from the cooperation control. In particular, since constant current charging is carried out at an initial stage of charging, the output from the charger circuit 41a is feedback-adjusted to adjust the charge voltage so that the charge current may be kept lower than fixed current. Then at a final stage, the charge voltage is kept equal to or lower than a fixed voltage. The charge voltage adjusted here is equal to or lower than the voltage adjusted by the cooperation control described above. By the control, a charging process is carried out within the electric power supplied from the control unit CU.

First, a change of the operating point when the cooperation control is carried out in the case where the illumination intensity upon the solar cell changes is described.

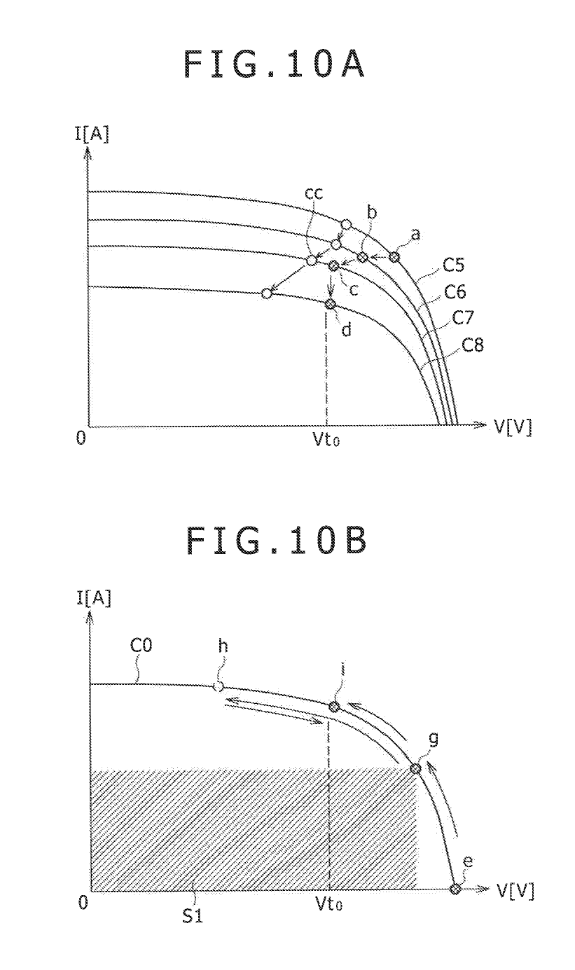

FIG. 10A illustrates a change of the operating point when the cooperation control is carried out in the case where the illumination intensity upon the solar cell decreases. In FIG. 10A, the axis of ordinate represents the terminal current of the solar cell and the axis of abscissa represents the terminal voltage of the solar cell. Further, a blank round mark in FIG. 10A represents an operating point when the MPPT control is carried out, and a shadowed round mark in FIG. 10A represents an operating point when the cooperation control is carried out. Curves C5 to C8 shown in FIG. 10A represent voltage current characteristics of the solar cell when the illumination intensity upon the solar cell changes.

It is assumed now that the electric power required by the battery Ba is 100 W (watt) and the voltage-current characteristic of the solar cell is represented by the curve C5 which corresponds to the most sunny weather state. Further, it is assumed that the operating point, of the solar cell at this time is represented, for example, by a point a on the curve C5, and the electric power or supply amount supplied from the solar cell to the battery Ba through the high voltage input power supply circuit 11 and the charger circuit 41a is higher than the electric power or demanded amount required by the battery Ba.

When the electric power supplied from the solar cell to the battery Ba is higher than the electric power required by the battery Ba, the output voltage from the control unit CU to the battery unit BUa, namely the voltage V12, is 48 V of the upper limit. In particular, since the input voltage to the battery unit BUa is 48 V of the upper limit, the output voltage from the charger circuit 41a of the battery unit BUa is 42 V of the upper limit, and charge into the battery Ba is carried out at the charge rate of 100%. It is to be noted that surplus electric power is abandoned, for example, as heat. It is to be noted that, although it has been described that the charge into the battery is carried out at 100%, the into the battery is not limited to 100% but can be adjusted suitably in accordance with a characteristic of the battery.

If the sky begins to become cloudy from this state, then the curve representative of the voltage-current characteristic of the solar cell changes from the curve C5 to the curve C6. As the sky becomes cloudy, the terminal voltage of the solar cell gradually drops, and also the output voltage from the control unit CU to the battery unit BUa gradually drops. Accordingly, as the curve representative of the voltage-current characteristic of the solar cell chances from the curve C5 to the curve C6, the operating point of the solar cell moves, for example, to a point b on the curve C6.

If the sky becomes cloudier from this state, then the curve representative of the voltage-current characteristic of the solar cell changes from the curve C6 to the curve C7, and as the terminal voltage of the solar cell gradually drops, also the output voltage from the control, unit CU to the battery unit BUa drops. When the output voltage from the control unit CU to the battery unit BUa drops by some degree, the control system cannot supply the electric power of 100% to the battery Ba any more.

Here, if the terminal voltage of the solar cell approaches Vt₀=75 V of the lower limit from 100 V, then the high voltage input power supply circuit 11 of the control unit CU begins to step down the output voltage to the battery unit BUa from 48 V toward Vb=45 V.

After the output voltage from the control unit CU to the battery unit BUa begins to drop, the input voltage to the battery unit BUa drops, and consequently, the charger circuit 41a of the battery unit BUa begins to step down the output voltage to the battery Ba. When the output voltage from the charger circuit 41a drops, the charge current supplied to the battery Ba decreases, and the charging into the battery Ba connected to the charger circuit 41a is decelerated in other words, the charge rate into the battery Ba drops.

As the charge rate to the battery Ba drops, the power consumption decreases, and consequently, the load as viewed from the solar cell decreases. Consequently, the terminal voltage of the solar cell rises or recovers by the decreased amount of the load as viewed from the solar cell.

As the terminal voltage of the solar cell rises, the degree of the drop of the output voltage from the control unit CU to the battery unit BUa decreases and the input voltage to the battery unit BUa rises. As the input voltage to the battery unit BUa rises, the charger circuit 41a of the battery unit BUa steps up the output voltage from the charger circuit 41a to raise the charge rate into the battery Ba.

As the charge rate into the battery Ba rises, the load as viewed from the solar cell increases and the terminal voltage of the solar cell drops by the increased amount of the load as viewed from the solar cell. As the terminal voltage of the solar cell drops, the high voltage input power supply circuit 11 of the control unit CU steps down the output voltage to the battery unit BUa.

Thereafter, the adjustment of the charge rate described above is repeated automatically until the output voltage from the control unit CU to the battery unit BUa converges to a certain value to establish a balance between the demand and the supply of the electric bower.

The cooperation control is different from the MPPT control in that it is not controlled by software. Therefore, the cooperation control does not require calculation of the terminal voltage which provides a maximum operating point. Further, the adjustment of the charge rate by the cooperation control does not include calculation by a CPU. Therefore, the cooperation control is low in power consumption in comparison with the MPPT control, and also the charge rate adjustment described above is executed in such a short period of time of approximately several nanoseconds to several hundred nanoseconds.

Further, since the high voltage input power supply circuit 11 and the charger circuit 41a merely detect the magnitude of the input voltage thereto and adjust the output voltage, analog/digital conversion is not required and also communication between the control unit CU and the battery unit BUa is not required. Accordingly, the cooperation control does not require complicated circuitry, and the circuit for implementing the cooperation control is small in scale.

Here, it is assumed that, at the point a on the curve C5, the control unit CU can supply the electric power of 100 W and the output voltage from the control unit CU to the battery unit BUa converges to a certain value. Further, it is assumed that the operating point of the solar cell changes, for example, to the point c on the curve C7. At this time, the electric power supplied to the battery Ba becomes lower than 100 W. However, as seen in FIG. 10A, depending upon selection of the value of the voltage Vt₀, electric power which is not inferior to that in the case wherein the MPPT control is carried out can be supplied to the battery Ba.

If the sky becomes further cloudy, then the curve representative of the voltage-current characteristic of the solar cell changes from the curve C7 to the curve C8, and the operating point of the solar cell changes, for example, to a point d on the curve C8.

As seen in FIG. 10A, since, under the cooperation control, the balance between the demand and the supply of electric power is adjusted, the terminal voltage of the solar cell does not become lower than the voltage Vt₀. In other words, under the cooperation control, even if the illumination intensity on the solar cell drops extremely, the terminal voltage of the solar cell does not become lower than the voltage Vt₀ at all.

If the illumination intensity on the solar cell drops extremely, then the terminal voltage of the solar cell comes to exhibit a value proximate to the voltage Vt₀, and the amount of current supplied to the battery Ba becomes very small. Accordingly, when the illumination intensity on the solar cell drops extremely, although time is required for charging of the battery Ba, since the demand and the supply of electric power in the control system are balanced well with each other, the control system does not suffer from the system down.

Since the adjustment of the charge rate by the cooperation control is executed in very short time as described above, according to the cooperation control, even if the sky suddenly begins to become cloudy and the illumination intensity on the solar cell decreases suddenly, the system down of the control system can be avoided.

Now, a change of the operating point when the cooperation control is carried out in the case where the load as viewed from the solar cell changes is described.

FIG. 10B illustrates a change of the operating point when the cooperation control is carried out in the case where the load as viewed from the solar cell increases. In FIG. 10B, the axis of ordinate represents the terminal current of the solar cell and the axis of abscissa represents the terminal voltage of the solar cell. Further, a shadowed round mark in FIG. 10B represents an operating point when the cooperation control is carried out.

It is assumed now that the illumination intensity on the solar cell does not change and the voltage-current characteristic of the solar cell is represented by a curve C0 shown in FIG. 10B.

Immediate after the control system is started up, it estimates that the power consumption in the inside thereof is almost zero, and therefore, the terminal voltage of the solar cell may be considered substantially equal to the open voltage. Accordingly, the operating point of the solar cell immediately after the startup of the control system may be considered existing, for example, at a point e on the curve C0. It is to be noted that the output voltage from the control unit CU to the battery unit BUa may be considered to be 48 V of the upper limit.

After supply of electric power to the battery Ba connected to the battery unit BUa is started, the operating point of the solar cell moves, for example, a point g on the curve C0. It is to be noted that, since, in the description of the present example, the electric power required by the battery Ba is 100 W, the area of a region S1 indicated by a shadow in FIG. 10B is equal to 100 W.

When the operating point of the solar cell is at the point g on the curve C0, the control system is in a state in which the electric power supplied from the solar cell to the battery Ba through the high voltage input bower supply circuit 11 and the charger circuit 41a is higher than the electric power required by the battery Ba. Accordingly, the terminal voltage of the solar cell, the output voltage from the control unit CU and the voltage supplied to the battery Ba when the operating point of the solar cell is at the point g on the curve C0 are 100 V, 48 V and 42 V, respectively.

Here, it is assumed that the battery unit BUb having a configuration similar to that of the battery unit BUa is newly connected to the control unit CU. If it is assumed that the battery Bb connected to the battery unit. BUb requires electric power of 100 W for the charge thereof similarly to the battery Ba connected to the battery unit BUa, then the power consumption increases and the load as viewed from the solar cell increases suddenly.

In order to supply totaling electric power of 200 W to the two batteries, the totaling output current must be doubled, for example, while the output voltage from the charger circuit 41a of the battery unit BUa and the charger circuit 41b of the battery unit BUb is maintained.

However, where the power generator is the solar cell, also the terminal voltage of the solar cell drops together with increase of output current from the charger circuits 41a and 41b. Therefore, the totaling output current must be higher than twice in comparison with that in the case when the operating point of the solar cell is at the point g. Therefore, the operating point of the solar cell must be, for example, at a point h on the curve C0 as shown in FIG. 10B, and the terminal voltage of the solar cell drops extremely. If the terminal voltage of the solar cell drops extremely, then the control system may suffer from system down.

In the cooperation control, if the terminal voltage of the solar cell drops as a result of new or additional connection of the battery unit BUb, then adjustment of the balance between the demand and the supply of electric power in the control system is carried out. In particular, the charge rate into the two batteries is lowered automatically so that electric power supplied to the battery Ba and the battery Bb may totally become, for example, 150 W.

In particular, if the terminal voltage of the solar cell drops as a result or new connection of the battery unit BUb, then also the output voltage from the control unit. CU to the battery units BUa and BUb drops. If the terminal voltage of the solar cell approaches Vt₀=75 V of the lower limit from 100 V, then the high voltage input power supply circuit 11 of the control unit CU begins to step down the output voltage to the battery units BUa and BUb toward Vb=45 V from 48 V.

As the output voltage from the control unit CU to the battery units BUa and BUb is stepped down, the input voltage to the battery units BUa and BUb drops. Consequently, the charger circuit 41a of the battery unit BUa and the charger circuit 41b of the battery unit BUb begin to step down the output voltage to the batteries Ba and Bb, respectively. As the output voltage from the charger circuit drops, the charging into the batteries connected to the charger circuit is decelerated. In other words, the charge rate to each battery is lowered.

As the charge rate into each battery is lowered, the power consumption decrease as a whole, and consequently, the load as viewed from the solar cell decreases and the terminal voltage of the solar cell rises or recovers by an amount corresponding to the decreasing amount of the load as viewed from the solar cell.

Thereafter, adjustment of the charge rate is carried out until, the output voltage from the control unit CU to the battery units BUa and BUb converges to a certain value to establish a balance between the demand and the supply of electric power in a similar manner as in the case where the illumination intensity on the solar cell decreases suddenly.

It is to be noted that it depends upon the situation to which value the voltage value actually converges. Therefore, although the value to which the voltage value actually converges is not known clearly, since charging stops when the terminal voltage of the solar cell becomes equal to Vt₀=75 V of the lower limit, it is estimated that the voltage value converges to a value a little higher than the value of Vt₀ of the lower limit. Further, it is estimated that, since the individual battery units are not controlled in an interlocking relationship with each other, even if the individual battery units have the same configuration, the charge rate differs among the individual battery units due to a dispersion of used elements. However, there is no change in that the battery units can generally be controlled by the cooperation control.

Since the adjustment of the charge rate by the cooperation control is executed in a very short period of time, if the battery unit BUb is connected newly, then the operating point of the solar cell changes from the point g to a point i on the curve C0. It is to be noted that, while a point h is illustrated as an example of the operating point of the solar cell on the curve C0 for the convenience of description in FIG. 10B, under the cooperation control, the operating point of the solar cell does not actually change to the point h.

In this manner, in the cooperation control, the charger circuit of the individual battery unite BU detects the magnitude of the input voltage thereto in response to an increase of the load as viewed from the solar cell, and automatically suppresses the current amount to be sucked thereby. According to the cooperation control, even if the number of those battery units BU which are connected to the control unit CU increases to suddenly increase the load as viewed from the solar cell, otherwise possible system down of the control system can be prevented.

Now, a change of the operating point when the cooperation control is carried out in the case where both of the illumination intensity on the solar cell and the load as viewed from the solar cell vary is described.

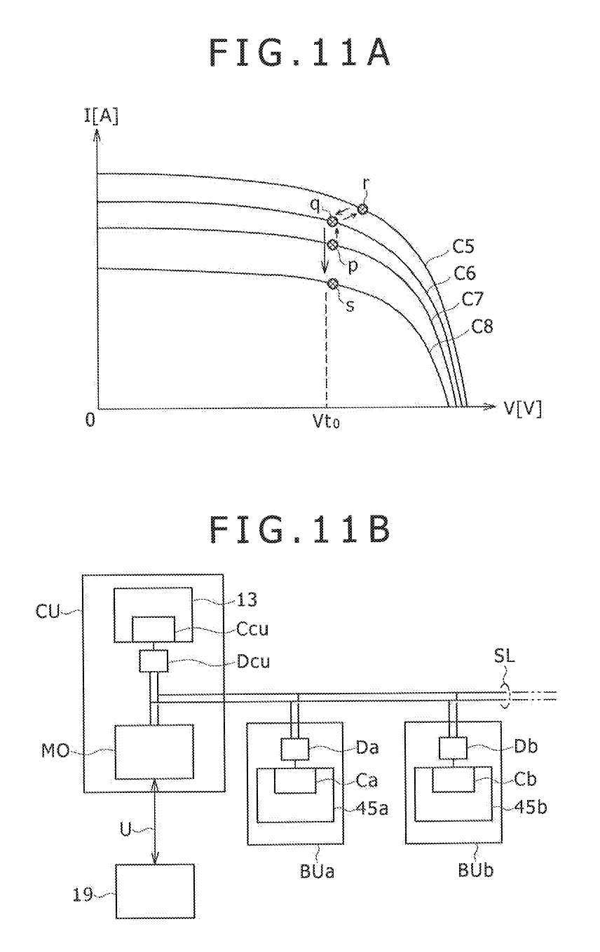

FIG. 11A illustrates a change of the operating point when the cooperation control is carried out in the case where both of the illumination intensity on the solar cell and the load as viewed from the solar cell vary. In FIG. 11A, the axis of ordinate represents the terminal current of the solar cell and the axis of abscissa represents the terminal voltage of the solar cell. A shadowed round mark in FIG. 11A represents an operating point when the cooperation control is carried out. Curves C5 to C8 shown in FIG. 11A indicate voltage current characteristics of the solar cell in the case where the illumination intensity upon the solar cell varies.

First, it is assumed that the battery unit BUa which includes the battery Ba which requires the electric power of 100 W for the charging thereof is connected to the control unit CU. Also it is assumed that the voltage current characteristic of the solar cell at this time is represented by a curve C7 and the operating point of the solar cell is represented by a point p on the curve C7.

It is assumed that the terminal voltage of the solar cell at the point p considerably approaches the voltage Vt₀ set in advance as a lower limit to the output voltage of the solar cell. That the terminal voltage of the solar cell considerably approaches the voltage V₀ signifies that, in the control system, adjustment of the charge rate by the cooperation control is executed and the charge rate is suppressed significantly. In particular, in the state in which the operating point of the solar cells represented by the point p shown in FIG. 11A, the electric power supplied to the battery Ba through the charger circuit 41a is considerably higher than the electric power supplied to the high voltage input power supply circuit 11 from the solar cell. Accordingly, in the state in which the operating point of the solar cell is represented by the point p shown in FIG. 11A, adjustment of the charge rate is carried out by a great amount, and electric power considerably lower than 100 W is supplied to the charger circuit 41a which charges the battery Ba.

It is assumed that the illumination intensity upon the solar cell thereafter increases and the curve representative of the voltage-current characteristic of the solar cell changes from the curve C7 to the curve C6. Further, it is assumed that the battery unit BUb which has a configuration similar to that of the battery unit BUa is newly connected to the control unit CU. At this time, the operating point of the solar cell, changes, for example, from the point p on the curve C7 to a point q on the curve C6.

Since the two battery units are connected to the control unit CU, the power consumption when the charger circuits 41a and 41b fully charge the batteries Ba and Bb is 200 W. However, when the illumination intensity upon the solar cell is not sufficient, the cooperation control is continued and the power consumption is adjusted to a value lower than 200 W such as, for example, to 150 W.

It is assumed here that the sky thereafter clears up and the curve representative of the voltage-current characteristic of the solar cell changes from the curve C6 to the curve C5. At this time when the generated electric power of the solar cell increases together with the increase of the illumination intensity upon the solar cell, the output current from the solar cell increases.

If the illumination intensity upon the solar cell increases sufficiently and the generated electric power of the solar cell further increases, then the terminal voltage of the solar cell becomes sufficiently higher than the voltage Vt₀ at a certain point. If the electric power supplied from the solar cell to the two batteries through the high voltage input power supply circuit 11 and the charger circuits 41a and 41b comes to be higher than the electric power required to charge the two batteries, then the adjustment of the charge rate by the cooperation control is moderated or automatically cancelled.

At this time, the operating point of the solar cell is represented, for example, by a point r on the curve C5 and charging into the individual batteries Ba and Bb is carried out at the charge rate of 100%.

Then, it is assumed that the illumination intensity upon the solar cell decreases and the curve representative of the voltage-current characteristic of the solar cell chances from the curve 35 to the curve C6.

When the terminal voltage of the solar cell drops and approaches the voltage Vt₀ set in advance, the adjustment of the charge rate by the cooperation control is executed again. The operating point of the solar cell at this point of time is represented by a point q of the curve C6.

It is assumed that the illumination intensity on the solar cell thereafter decreases further and the curve representative of the voltage-current characteristic of the solar cell changes from the curve C6 to the curve C8.

Consequently, since the charge rate is adjusted so that the operating point of the solar cell may not become lower than the voltage Vt₀, the terminal current from the solar cell decreases, and the operating point of the solar cell changes from the point q on the curve C6 to a point s on the curve C8.

In the cooperation control, the balance between the demand and the supply of electric power between the control unit CU and the individual battery units BU is adjusted so that the input voltage to the individual battery units BU may not become lower than the voltage Vt₀ determined in advance. Accordingly, with the cooperation control, the charge rate into the individual batteries B can be changed on the real time basis in response to the supplying capacity of the input, side as viewed from the individual battery units BU. In this manner, the cooperation control can cope not only with a variation of the illumination intensity on the solar cell but also with a variation of the load as viewed from the solar cell.

As described hereinabove, the present disclosure does not require a commercial power supply. Accordingly, the present disclosure is effective also in a district in which a per supply apparatus or electrical power network is not maintained.

[Communication between the Control Unit and the Battery Units]

FIG. 11B shows an example of a configuration for communication connection between a control unit and a plurality of battery units. FIG. 11B particularly shows an example wherein a plurality of battery units BU and one PC 19 are connected to one control unit CU. Further, FIG. 11B shows only two of a plurality of battery units BU, particularly a battery unit BUa and another battery unit BUb. Naturally, the number of battery units BU to be connected to the control unit CU is not limited to two.

Referring to FIG. 11B, the CPU 13 in the control unit CU communicates with a connected apparatus such as, for example, a battery unit BU or a personal computer, for example, through a communication section Ccu and a driver Dcu. The communication between the control unit CU and a plurality of battery unite. BU is carried out between the CPU 13 of the control unit CU and CPUs 45a, 45b, . . . of the individual battery units BU, for example, through a signal line SL.

The communication between the control unit CU and the battery units BU is carried out, for example, in compliance with the RS-485 standard. Accordingly, for example, the CPU 45a of the battery unit BUa communicates with the control unit CU through the communication section Ca and the driver Da. Similarly, the CPU 45b of the battery unit BUb communicates with the control unit CU through communication section Cb and the driver Db.

For example, a personal computer or the like may be connected to the control unit CU by a UPS (Universal Serial Bus) cable U or the like. Since the personal computer or the like is connected to the control unit CU, also it is possible to control operation of the control system 1 from the personal computer connected to the control unit CU.

The communication between the control unit CU and the PC 19 is carried out, for example, in compliance with the USB standard. It is to be noted that a conversion module MO in the control unit CU shown in FIG. 118 is provided for conversion, for example, between the RS-485 standard and the RS-232 standard and between the RS-232 standard and the USB standard.

### [Grasp of the Number and State of the Battery Units]

As described hereinabove, in the control system 1, it is possible to control a plurality of battery units BU independently of each other. For example, the control unit. CU determines to which one or ones of a plurality of battery units BU connected thereto a charging instruction or a discharging instruction is to be provided, and issues a charging or discharging instruction to the designated battery unit or units BU. Accordingly, it is necessary for the control unit CU to grasp the number of battery units BU connected thereto before issuance of a charging or discharging instruction.

The control unit CU grasps the number of battery units BU connected thereto at the present point of time in the following manner.

In order to grasp the number of battery units BU connected to the control unit CU at the present point of time, the control unit CU first establishes a link to a connected apparatus connected thereto at present. Generally, the control unit CU normally signals a calling command to a communication path. If a response to the command is found, then the control unit CU allots an ID (Identification) for communication to each of those connected apparatus from which a response is received. The ID for communication, hereinafter referred to suitably as connection ID, is used for the identification of each of the connected apparatus which are connected to the control, unit CU at present.

For the establishment of a link between the control, unit CU and each of those battery units BU which are connected to the control unit CU at present, more particularly an ID unique to the battery unit, namely, a unique ID, is used. The unique ID includes, for example, information of a type, a fabrication serial number and so forth of the battery B provided in the battery unit BU. Accordingly, the control unit CU can identify the type and so forth of the battery B provided in the battery unit BU from the unique ID.

An example of an establishment procedure of a link under the assumption that no connection ID is allotted to all of the battery units BU connected to the control unit CU is described below. Further, it is assumed that no battery unit BU is newly connected to or disconnected from the control, unit CU during the establishment of a link.

First, the control unit CU signals a calling command on the communication path. The destination of the calling command may be set, for example, to all connected apparatus including connected apparatus to each of which a connection ID is allotted already, to only connected apparatus to which no connection ID is allotted or the like. The signaling of the command for requesting for establishment of communication continues until a response to the calling command is not received any more.

As seen in FIG. 11B, for example, the signal lines SL from the individual battery units BU are connected to each other therein, and what number of battery units BU are connected to the control unit CU cannot be detected unless signals are communicated therebetween. However, by the configuration described, for example, it is possible to connect a number of apparatus greater than the number of connectors prepared for the control unit CU to the control unit CU. Consequently, expandability can be provided to the control system 1.

The if a battery unit BU connected to the control unit CU receives the calling command described above, then it returns a response including the unique ID of the battery unit BU itself to the control unit CU.

The control unit CU receives the responses from the battery units BU and signals a command for requesting for establishment of communication successively to the battery units BU from which a response has been received. Each of the commands for requesting for establishment of communication includes the unique ID of the battery unit BU from which the response has been received.

Then, each of the individual battery units BU receives the command for requesting for establishment of communication and decides whether or not the unique ID included in the command coincides with the unique ID retained by the battery unit BU itself.

If the unique IDs coincide with each other, then the battery unit BU returns a response for approving establishment of communication to the control unit CU. On the other hand, if the unique IDs do not coincide with each other, then the battery unit BU does not return a response to the control unit CU.

When the control unit CU receives the response which approves establishment of communication, connection between the battery unit BU from which the response has been received and the control unit CU is established. In other words, the connection ID for designating the battery unit BU from which the response has been returned is determined finally.

Transfer of a command for requesting for establishing communication and a response to the command is repeated until transfer to and from all battery units BU from which a response to the calling command is received comes to an end. It is to be noted that, if the transfer to and from all battery units BU from which a response has been received to the calling command does not come to an end before time-out, then the processing is carried out again beginning with signaling of a calling command.

By the series of processes described above, allotment of connection IDs to the battery units BU connected to the control unit CU at present is carried out. At this time, the number of allotted connection IDs represents a number of battery units BU connected to the control unit CU at present when it is assumed that no battery unit BU is newly connected or disconnected.

Since the connection IDs are allotted to the battery units BU, for example, the control unit CU can communicate with a designated battery unit BU from among the battery units BU connected to the control unit CU at present.

For example, if a connection ID is allotted to each of the battery units BU connected at present, then the control unit CU can read out necessary information from any of the battery units BU by designating a target with its connection ID.

To each battery unit BU to which a connection ID is allotted, for example, various commands are sent from the control unit CU. Each battery unit BU which receives a command from the control unit CU executes analysis of the received command and a predetermined process. It is to be noted that each battery unit BU to which a connection ID is allotted processes only a packet in which the connection ID allotted to the battery unit BU itself is designated but abandons any packet in which a connection ID different from the connection ID allotted to the battery unit BU itself is designated.

As a command to the battery unit BU to which a connection ID is allotted, for example, commands for reading out data acquired by the temperature sensor 49, an input voltage to the battery unit BU, an output voltage of the battery unit BU and so forth are available.

For example, by causing a designated battery unit BU to carry out A/D conversion of an output voltage or discharge voltage of the battery B and carry out necessary arithmetic operation, the control unit CU can acquire information relating to the battery remaining capacity of the battery B. In particular, the battery unit BU which receives a command for reading out the battery remaining capacity of the battery B acquires an output voltage of the battery B from the voltage sensor 44b and carries out A/D conversion by the A/D conversion section 48 and required arithmetic operation by the CPU 45. A result of the arithmetic operation is signaled to the control unit CU. Accordingly, the control unit CU acquires information of a chargeable capacity or a dischargeable capacity of the battery B provided in the designated battery unit BU.

Further, for example, the control unit CU can control electric connection between a designated battery unit BU from among more than one battery unit BU and the control unit CU by controlling an electronic switch of the designated battery unit. In particular, the control unit CU can control charging/discharging of a designated one of more than one battery unit BU. In other words, charging/discharging of the designated battery unit is not started unless an instruction to start charging/discharging is received from the control unit CU.

In this manner, the control unit CU can monitor the state or the connectability of the individual battery units BU and carry out control for charging/discharging as occasion demands.

Here, it is considered that charging of a battery unit BU by generated electric power of the electric power generation section is preferably carried out preferentially beginning with that battery unit BU which includes the battery B having the lowest rated capacity. Or, charging of a battery unit BU by generated electric power of the electric power generation section is preferably carried out preferentially beginning with that battery unit BU which has the battery B which has the greatest chargeable capacity, that is, the greatest margin for charging. Similarly, when electric power is supplied, to an external apparatus from the control system 1, it is preferable that discharging is carried out preferentially beginning with the battery unit BU which includes the battery B which has the greatest chargeable capacity from among the battery units.

In other words, preferably the control of charging/discharging of the battery units BU is carried out based on information of the chargeable capacity/dischargeable capacity and so forth of the batteries B.

Information of the chargeable capacity/dischargeable capacity and so forth of the battery units BU can be acquired by the control unit CU by signaling a predetermined command to the battery units BU to each of which a connection ID is allotted and then receiving a response.

Therefore, the control unit CU successively signals, for example, a command for reading out the battery remaining capacity of the battery B to the battery units BU to each of which a connection ID is allotted to acquire information relating to the battery remaining capacity of the batteries B. By acquiring the information relating to the battery remaining capacity of the batteries B, the control unit CU can determine ranking regarding beginning with which one of the battery units BU charging/discharging is to be carried out.

Here, for example, it is assumed that four battery units BU are connected to the control unit CU, and the control unit CU tries to issue a charging/discharging instruction to two ones of the battery units BU. At this time, the control unit CU designates or selects those battery units BU which have the first and second ranks by the ranking determined based on the information relating to the battery remaining capacities of the batteries B. Then, the control unit CU issues a charging/discharging instruction to the designated battery units BU.

Incidentally, transfer of commands/responses between the control unit CU and the battery units BU in the configuration example of the control system of the embodiment of the present disclosure is executed independently in a unit of a command/response. In particular, after the control unit CU signals a certain command A, it advances to execution of another process. Then, when a response B to the signaled command A is received, the control unit CU executes a process corresponding to the response B.

In particular, if a response to a signaled command is received before time-out, then the control unit CU executes a process corresponding to the received response every time. Further, each of the battery units BU analyzes a received commend every time to decide what process should be executed at the point of time. This is because, in the configuration example of the control system of the embodiment of the present disclosure, a plurality of battery units BU can be controlled independently of each other and each battery unit BU can be newly connected and disconnected as described hereinabove.

In the configuration example of the control, system of the embodiment of the present disclosure, the number of battery units BU connected to the control unit CU can change while charging into or discharging from the battery units BU is being carried out. Accordingly, it is necessary for the control unit CU to normally monitor the number and state of the battery units BU connected to the control unit CU. Since the control unit CU and the battery units BU execute a process corresponding to a received command every time, the control unit CU can normally monitor the state of the battery units BU.

Therefore, the series of processes, hereinafter referred to as connection ID application sequence, for the allotment of a connection ID to each battery unit BU and the series of processes, hereinafter referred to as state monitoring sequence, for the state monitoring of the battery units BU connected to the control unit CU, are executed successively and repetitively.

In the following, an example of a method for normally monitoring the number and the state of battery units BU connected to the control unit CU is described. It is to be noted that, before the following procedure is executed, a variable Nt for storing the number of battery units BU at a certain point of time and a variable Nb for storing the number of battery units BU at a point, of time preceding by one cycle are prepared. Further, a flag representative of whether or not the number of battery units BU at the certain point of time and the number of battery units BU at the point of time preceding by one operation cycle are different from each other is prepared. The flag is hereinafter referred to suitably as unit number change flag.

The control unit CU repetitively executes the connection ID application sequence and the state monitoring sequence generally in parallel to each other in order to normally monitor the number and the state of the battery units BU which are connected to the control unit CU. In the following, description is given of a case in which a series of processes, hereinafter referred to suitably as capacity detection sequence, for reading out the battery remaining capacity of the battery B of each battery unit BU to which a connection ID is allotted is carried out as the state monitoring sequence. It is to be noted that the connection ID application sequence and the capacity detection sequence are executed repetitively while the control system 1 is operative.

In response to the calling command in the connection ID application sequence, only those battery units BU to which no connection ID is allotted return a response. Therefore, for example, if a battery unit BU is newly connected to the control unit CU or if a battery unit BU which has been disconnected once is connected again, then when the connection ID application sequence is repeated, the allotment of the connection ID is updated.

In the connection. ID application sequence, every time a connection ID is allotted, the variable Nt is incremented. In particular, the allotment of a connection ID is verification of whether or not there is a battery unit BU connected newly to the control unit CU. Further, that a connection ID is newly allotted signifies that there is a battery unit BU connected newly to the control unit CU, and therefore, the unit number change flag is set.

On the other hand, it is assumed that some battery unit BU does not return a response before time-out in the capacity detection sequence.

As described hereinabove, the command for reading out of the battery remaining capacity of the battery B in the battery unit BU is signaled only to those battery units BU to each of which a connection ID is allotted already. Accordingly, that a response to the command for reading out the battery remaining capacity of the battery B is not received signifies that the battery unit BU of the transmission destination of the command has been disconnected. Therefore, every time a battery unit BU which does not return a response before time-out is found, the variable Nt is decremented. Further, that a battery unit BU which does not return a response before time-out is found signifies that some battery unit BU has been disconnected from the control unit CU. Therefore, also in this instance, the unit number change flag is set.

In this manner, in the embodiment of the present disclosure, the command for verifying the state of the battery units BU also has a function as a command for verifying the number of battery units BU connected to the control unit CU at the present point of time. In particular, for example, the command for reading out the battery remaining capacity of the battery B is used for the verification of whether or not some battery unit BU is newly connected or disconnected. It is to be noted that the command for verifying the state of the battery units BU is not limited, to the command for reading out the battery remaining capacity of the battery B but may be, for example, a command for reading out the temperature in a battery unit BU or a like command.

If the acquisition of information of the battery remaining capacity of the battery B from all of the battery units BU connected to the control unit CU through allotment of a connection ID comes to an end, then this signifies that one unit of repetitions of the capacity detection sequence is ended. If one unit of repetitions of the capacity detection sequence comes to an end, then it is possible to construct a table of the ranking for charging/discharging based on, for example, the battery remaining capacity of each battery B. The count value of the variable Nt when the acquisition of information of the battery remaining capacity of the batteries B comes to an end represents the number of battery units BU connected to the control unit CU at the point of time. In this manner, even when some battery unit BU is newly connected or disconnected, the control unit CU can grasp the number and the state of the battery units BU connected to the control unit CU at a certain point of time.

After the acquisition of information, of the battery remaining capacity of the battery B from all of the battery units BU connected to the control unit CU at the present point of time comes to an end, the count value of the variable Nt is copied into a variable Nb. Then, the unit number change flag is reset, and thereafter, the series of processes described above is executed repetitively.

After the acquisition of information of the battery remaining capacity of the battery B from all of the battery units BU connected newly to the control unit CU comes to an end in the series of processes described above, the variable Nb and the variable Nt are compared with each other. In other words, the number of battery units BU connected to the control unit CU in a state preceding by one operation cycle and the number of battery units BU connected to the control unit CU at the present point of time are compared with each other.

If the variable Nb and the variable Nt coincide with each other, then it can be decided that the state of all of the battery units BU connected to the control unit CU at the present point of time, namely, the battery remaining capacity of the batteries B in the battery units BU, has been verified. Therefore, she control system 1 enters a mode in which charging/discharging can be carried out for the first time.

On the other hand, if the state of the battery B in all of the battery units BU whose connection has been verified is not verified, then the variable Nb and the variable Nt do not coincide with each other.

For example, it is assumed that, during acquisition of information of the battery remaining capacity of she battery B from all of the battery units BU connected to the control unit CU at the present point of time, the number of battery units BU increases or decreases. In other words, it is assumed that the number of battery units BU increases or decreases halfway of the state monitoring sequence. At this time, the state of all of the battery units BU which have been connected to the control unit CU may not be grasped.

Therefore, when the variable Nb and the variable Nt do not coincide with each other, the control system 1 does not enter a mode in which charging/discharging can be carried out, and the processing is returned to the allotment of a connection ID.

For example, it is assumed that connection IDs “AAA,” “BBB” and “CCC” are allotted to the three battery units BU connected to the control unit CU. At this point of time, the control unit CU decides that the total number of battery units BU connected thereto is three and continues various processes including the state monitoring sequence.

For example, it is assumed that, after the verification of the state of the battery unit BU having the connection ID “AAA,” the control unit CU carries out verification of the state of the battery unit BU which has the connection ID “BBB.” Further, it is assumed that, during the verification of the state of the battery unit BU having the connection ID “BBB,” the battery unit BU having the connection ID “AAA” whose state verification is completed already is disconnected. In this instance, before the number of battery units BU is verified subsequently, namely, before the connection ID application sequence is carried out again, although the number of battery units BU connected to the control unit CU actually is two, the control unit CU continues the processes determining that the number of battery units BU connected thereto is three.

It is to be noted that, for example, it is assumed that the battery units BU having the connection IDs “BBB” and “CCC” allotted thereto are connected to the control unit CU and the control unit CU is verifying the state of the battery unit BU having the connection ID “BBB.” At this time, if a battery unit BU is connected newly to the control unit CU, then “AAA” is newly allotted as a connection ID to the new battery unit BU.

In this instance, the control unit CU decides that the connection IDs “BBB,” “CCC” and “AAA” have been allotted. Consequently, when the state monitoring, sequence is repeated, verification of the state is carried out with regard to the battery unit BU to which the connection ID “AAA” is newly allotted.

If one unit of repetitions of the capacity detection sequence comes to an end as described above, then the state of all of the battery units BU connected to the control unit CU at the present point of time is grasped. After the state of all of the battery units BU connected to the control unit CU at the present point of time is grasped, a table of the ranking for charging/discharging is constructed, for example, based on the battery remaining capacity of the batteries B. Further, after completion of one unit of repetitions of the capacity detection sequence, it is decided whether or not the variable Nb and the variable Nt coincide with each other. If the variable Nb and the variable Nt coincide with each other, then the control system 1 enters a mode in which charging/discharging can be carried out.

After the control system 1 enters the mode in which charging/discharging can be carried out, the control unit CU issues a charging/discharging instruction to the battery units BU in accordance with the ranking for charging/discharging, for example, based on the battery remaining capacity of the batteries B.

Incidentally, in the embodiment of the present disclosure, for example, a command for reading out the battery remaining capacity of the batteries B is used for verification of whether or not a battery unit BU is additionally connected or disconnected.

From a point of view that the number or state of battery units BU connected to the control unit CU is normally monitored, preferably the verification regarding whether or not some battery unit BU is newly connected or disconnected is carried out after an interval of time as short as possible. In other words, preferably the capacity detection sequence is executed repetitively and the command for reading out the battery remaining capacity of the battery B continues to be signaled suitably.

However, since A/D conversion usually involves an error, if it is tried to estimate the capacity by which the battery B can be charged, namely, the dischargeable capacity, based on the output voltage of the battery B, namely, the discharge voltage, then the ranking for charging/discharging is updated in every repetition of the capacity detection sequence. In other words, the ranking for charging/discharging at a certain point of time and the ranking for charging/discharging at a point of time after the capacity detection sequence is carried out once again sometimes differ from each other. Particularly in the case where the difference in chargeable capacity or in dischargeable capacity between a plurality of batteries B is very small, the ranking for charging/discharging changes in every repetition of the capacity detection sequence.

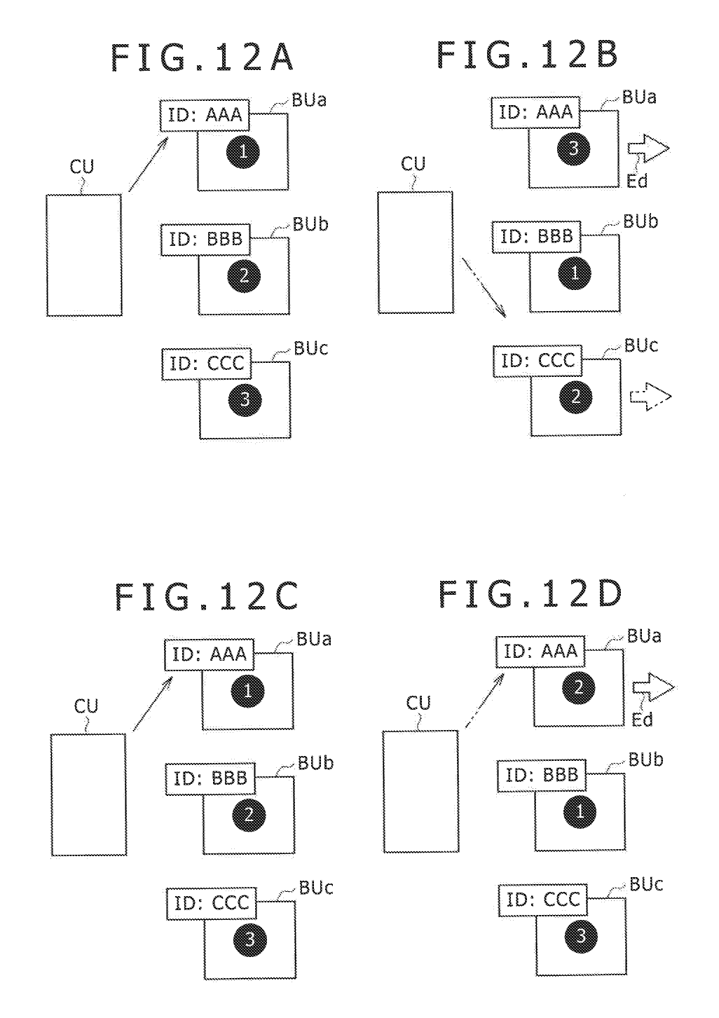

FIGS. 12A to 12D are diagrammatic views illustrating a relationship of the ranking for discharging to discharging instruction to a battery unit BU and discharging from the battery unit BU.

It is assumed that, for example, at a certain point of time, the control unit CU accommodates the three battery units BUa, BUb and BUc as seen in FIG. 12A. Further, it is assumed that the connection IDs “AAA,” “BBB” and “CCC” are allotted, in order as connection IDs to the battery units BUa, BUb and BUc, respectively. Furthermore, it is assumed that the battery remaining capacities of the batteries Ba, Bb and Bc in the battery units BUa, BUb and BUc at this point of time are, for example, 90, 89 and 88% with respect to the respective rated capacities, respectively.

At this time, it is assumed that, for example, the control unit CU is set so as to issue a discharging instruction preferentially beginning with the battery unit BU which includes the battery B which has the greatest dischargeable capacity. In particular, according to the ranking for discharging at the present point of time, the battery unit BUa has the first rank; the battery unit BUb has the second rank; and the battery unit BUc has the third rank.

It is to be noted that a blank numeral in a solid round mark in FIGS. 12A to 12D represents a rank for discharging at the present point of time. This similarly applies also in the following description.

Accordingly, when electric power is supplied from the control system 1 to an external apparatus, the control unit CU issues a discharging instruction to the battery unit BUa which has the highest rank for discharging at the present point of time as indicated by an arrow mark in FIG. 12A. The discharging instruction to the battery unit BUa at the time is signaled from the control unit CU with a transmission designation designated by the connection ID.

However, within a period from issuance of a discharging instruction in the state illustrated in FIG. 12A to next issuance of the discharging instruction, one unit of a repetition of the connection ID application sequence and the capacity detection sequence ends and the ranking for discharging sometimes changes, for example, as seen from FIG. 12B. This is because, in the configuration example of the control system of the embodiment of the present disclosure, the control unit CU is executing a different process also within a period for which it waits a response to the command.

FIG. 12B illustrates an example of the ranking for discharging at a point of time at which one unit of repetitions of the connection ID application sequence and the capacity detection sequence after the state illustrated in FIG. 12A comes to an end. In the example as illustrated in FIG. 12B, at a point of time at which one unit of a repetition of the capacity detection sequence comes to an end, the ranking for discharging is such that the battery unit BUa has the third rank; the battery unit BUb has the first rank; and the battery unit BUc has the second rank.

As seen in FIG. 12B, for example, at this point of time, discharging from the battery unit BUa has been started as schematically indicated by an arrow mark Ed. In particular, although originally discharging should be carried out from the battery unit BUb which has the first rank for discharging at the present point of time, discharging is carried out from the battery unit BUa which has the third rank for discharging at the present point of time.

Further, it is assumed that electric power required by the external apparatus has increased and it has become necessary to carry out discharging also from a second battery unit. Then, the control unit CU comes to have to issue a discharging instruction to the battery unit BUc which has the second rank for discharging based on the ranking for discharging at this point of time. It is to be noted that the control unit CU can issue a discharging instruction to a second battery unit BU in addition to the battery unit BUa only after the coincidence between the variable Nb and the variable Nt is detected. In particular, since verification of the state has been completed with regard to all battery units BU connected to the control unit CU at present, it is guaranteed that the ranking for charging/discharging is settled.

However, if the control, unit CU issues a discharging instruction to the battery unit BUc which has the second rank at this point of time, then the battery unit BUb which includes the battery Bb which has the greatest dischargeable capacity at this point of time will be overlooked.

It is assumed that the control unit CU issues a discharging instruction to the battery unit BUc which has the second rank for discharging at this point of time. However, at a point of time at which one unit of a repetition of the capacity detection sequence comes to an end subsequently, there is no guarantee that the rank for discharging of the battery unit BUc is the second rank.

Further, it is assumed that, for example, the ranking for discharging at a certain point of time is such that the battery unit BUa has the first rank, the battery unit BUb has the second rank and the battery unit BUc has the third rank as seen in FIG. 12C. At this time it is assumed that the control unit CU issues a discharging instruction to the battery unit BUa as indicated by an arrow mark in FIG. 12C based on the ranking for discharging.

It is assumed that, when discharging from the battery unit BUa is started and then next one unit of a repetition of the capacity detection sequence comes to an end, the ranking for discharging has changed as seen, for example, in FIG. 12D. In the example illustrated in FIG. 12D, at the end of the one unit of a repetition of the capacity detection sequence, the ranking for discharging is such that the battery unit BUa has the second rank, the battery unit BUb has the first rank and the battery unit BUc has the third rank. For example, at this point of time, discharging from the battery unit BUa has been started as indicated by an arrow mark Ed in FIG. 12D.

If it is assumed that, at this time, it becomes necessary to carry out discharging also from a second battery unit, the control unit CU comes to have to issue a discharging instruction to the battery unit BUa which has the second rank for discharging at this point of time based on the ranking for discharging. However, the battery unit BUa has started discharging already, and the discharging instruction from the control unit CU is signaled in an overlapping relationship toward the battery unit BUa.

In this manner, if it is tried to issue a charging/discharging instruction to a plurality of battery units based on the ranking for charging/discharging, then there is the possibility that the control system may malfunction.

Further, in the configuration example of the control system of the embodiment of the present disclosure, the number of battery units BU mounted on the control unit CU may possibly change while charging or discharging into or from the battery units BU is being carried out.

For example, it is assumed to further issue, after a charging/discharging instruction is issued at a certain point of time to the battery unit BU which has the nth in is a natural number) rank for charging/discharging, a charging/discharging instruction to the battery unit BU which has the (n+1)th rank.

However, in the configuration example of the control system of the embodiment of the present disclosure, the number of battery units BU may possibly change between instruction to the nth battery unit BU and instruction to the (n+1)th battery unit BU. Consequently, a situation in which the (n+1)th battery unit BU which is a target of the instruction does not exist may possibly occur.

Further, if the number of battery units BU connected to the control unit CU changes, then since a repetition of the capacity detection sequence is carried out, the ranking for charging/discharging is updated. In this instance, if a charging/discharging instruction is issued simply to a plurality of battery units BU based on the ranking for charging/discharging at the point of time, then a different unfavorable situation may possibly occur in addition to the problem described above.

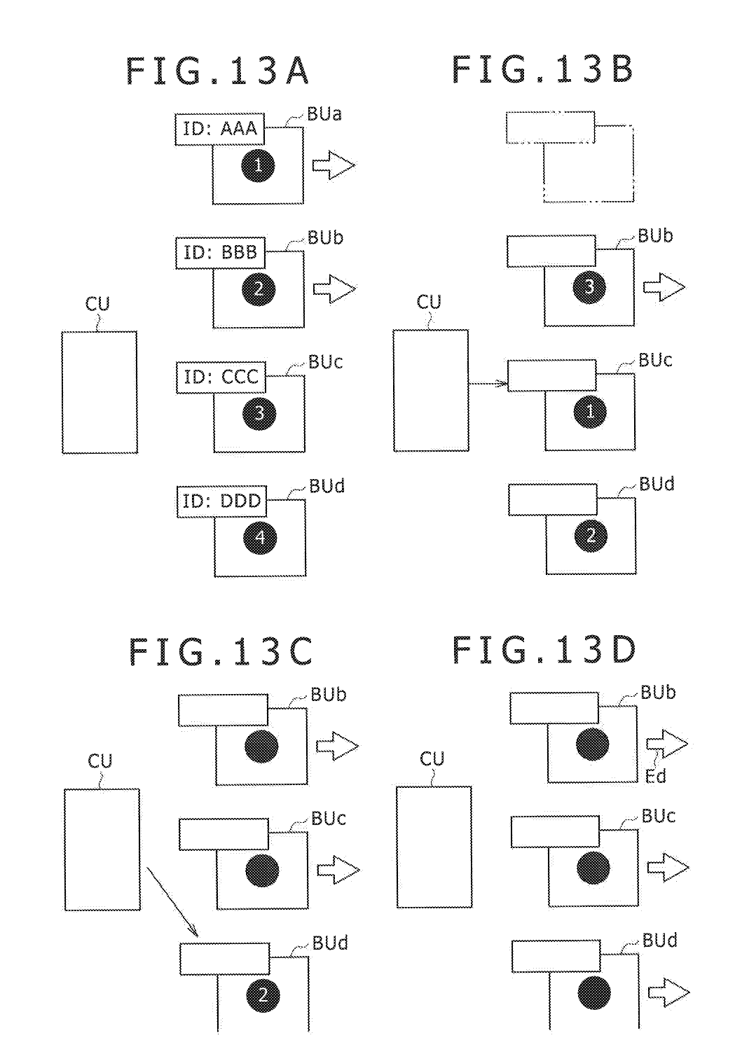

FIGS. 13A to 13D are diagrammatic views illustrating a relationship of a ranking for discharging to discharging instruction to a battery unit BU and discharging from the battery unit BU.

It is assumed that, for example, at a certain point of time, the control unit CU accommodates four battery units BUa, BUb, BUc and BUd as seen in FIG. 13A. Also it is assumed that connection IDs “AAA,” “BBB,” “CCC” and “DDD” are allotted in order to the battery units BUa, BUb, BUc and BUd, respectively. Further, it is assumed that, at this point of time, the ranking for discharging is such that the battery unit BUa has the first rank; the battery unit BUb has the second rank; the battery unit BUc has the third rank; and the battery unit BUd has the fourth rank. Furthermore, it is assumed that, at this point of time, discharging is being carried out, for example, from two battery units BU.

Then, it is assumed that, for example, the battery unit BUa is disconnected from the control unit CU as seen in FIG. 13B. Consequently, the ranking for discharging among the battery units BUb, BUc and BUd is updated in response to a repetition of the capacity detection sequence. It is assumed that, in the state illustrated in FIG. 13B, the ranking for discharging is such that the battery unit BUb has the third rank; the battery unit BUc has the first rank; and the battery unit BUd has the second rank.

If a decision is made simply from the fact that it is necessary for two battery units to discharge and further from the ranking for discharging in the state illustrated in FIG. 13B, then the battery units BU having the first rank and the second rank for discharging ought to discharge. Therefore, the control unit CU must issue a discharging instruction to the battery unit BUc which has the first rank for discharging at this point of time. At this time, discharging is being continued from the battery unit BUb to which a charging instruction has been issued.

It is to be noted that, in the state illustrated in FIG. 13B, there is the possibility that the connection IDs allotted to the battery units BU have been changed from those in the state illustrated in FIG. 13A. However, in the following description, the connection IDs are suitably omitted. This is because, in order for the control unit CU to issue a charging/discharging instruction to the battery unit BUc, only it is necessary for a connection ID to be allotted to each battery unit BU. Also this is a reason that, in the series of processes described above, a discharging instruction is issued from the control unit CU after connection IDs and a ranking for charging/discharging are determined finally.

Now, it is assumed that, within a period from issuance of a discharging instruction to the battery unit BUc to starting of actual discharging by the battery unit BUc, one unit of a repetition of the capacity detection sequence comes to an end and the ranking for discharging is changed as seen in FIG. 13C.

It is assumed that the battery unit BU which has the second rank for discharging at this point of time is, for example, the battery unit BUd as seen in FIG. 13C. In this instance, the control unit CU comes to issue a discharging instruction to the battery unit BUd having the second rank for discharging in order to cause the battery unit BUd to discharge. At this time, discharging from the battery unit BUb and the battery unit BUc which have been instructed to discharge is continued.

If a charging instruction is issued to the battery unit BUd, then the battery unit BUd starts discharging. Therefore, although originally discharging ought to be carried out from two battery units BU, discharging is actually carried out from three battery units BU. In other words, if a discharging instruction is issued simply to a plurality of battery units BU based on the ranking at the current point of time, then as time passes, the number of battery units BU which discharge gradually increases.

Similarly, also in the case of charging, if a charging instruction is issued simply to a plurality of battery units BU based on the ranking for charging at the current point of time, then the number of battery units BU which charge gradually increases. In other words, the power consumption continues to increase, and the load as viewed from the electric power generation section continues to increase.

In short, if a plurality of battery units BU can be freely connected additionally or disconnected, then change of the ranking for charging/discharging may possibly occur within a period from issuance of an instruction from the control unit CU to the a battery unit BU to operation of the battery unit BU which receives the instruction. In other words, there is no guarantee that an instruction based on the ranking for charging/discharging at a certain point of time is an instruction conforming to the ranking for charging/discharging at a preceding point of time.

Such a problem as described above need not have been assumed for a popular control apparatus which is free from a change in connection number of secondary cells upon charging into the secondary cells or upon discharging from the secondary cells.

The applicant has intensively studied to solve the problems described above and has successfully devised the electric power controlling method, electric power controlling apparatus and electric power controlling program of embodiments of the present disclosure.

### [Charging Procedure Where a Plurality of Battery Units are Involved]

First, a charging procedure which can be applied to the embodiment of the present disclosure is described. The procedure described below is applied when a battery unit BU which is to start charging is to be increased newly.

In the charging procedure of the embodiment of the present disclosure, generally when a battery unit BU is newly connected or disconnected before a charging instruction is issued from the control unit CU to a certain battery unit BU, the control unit CU successively cancels charging into all battery units BU. After the charging into all battery units BU is canceled, the control unit CU issues a charging starting instruction to the battery unit BU which has the highest rank for charging at a point of time at which the instruction is to be issued. After the charging instruction is issued to a first one of the battery units, if new connection or disconnection of a battery unit BU is not carried out, then the control unit CU successively issues a charging starting instruction to the battery units BU until the number of battery units BU to which a charging instruction is to be issued is reached.

FIG. 14 is a flow chart illustrating an example in the case where a charging instruction is issued to a plurality of battery units based on the ranking for charging. The series of processes described below is executed, for example, by the CPU 13 of the control unit CU.

As described hereinabove, the control system 1 does not enter a mode in which charging can be carried out unless verification of the state comes to an end with regard to all battery units BU connected to the control unit CU at the current point of time. In other words, if the variable Nb and the variable Nt described hereinabove coincide with each other, then the control system 1 enters a mode in which charging can be carried out. It is to be noted that, if the variable Nb and the variable Nt do not coincide with each other, then the processing is returned to a repetition of the connection ID application sequence and the state monitoring sequence. The mode in which charging can be carried out is hereinafter referred to suitably as “charging mode,”

In the charging mode, first at step St31, it is decided whether or not the number of battery units BU connected to the control unit CU has changed. In other words, for example, it is decided whether or not the unit number change flag is in a set state.

If the number of battery units BU connected to the control unit CU has changed, the processing advances to step St32. On the other hand, if the number of battery units BU connected to the control unit CU has not changed, then the processing advances to step St37.

If it is decided at step St31 that the number of battery units BU connected to the control unit CU has changed, then it is decided at step St32 whether or not charging into all battery units BU connected to the control unit CU has been stopped. If any battery unit BU which is continuing charging is found, then a charging stopping command is signaled at step St36 to the battery unit BU which continues charging. It is to be noted that, after the charging stopping command is signaled, the processing may be returned to step St31.

In particular, if the number of battery units BU changes when the control system 1 is in a mode in which charging takes priority, then the charging into all battery units BU is canceled once. The reason why the charging into all battery units BU is canceled once is that it is intended to prevent increase of the number oil battery units BU which carry out charging. It is to be noted that, if the process of the present example is applied, when from within electric power obtained from the electric power generation section, some power is not used for charging but is discarded. However, the period of time within which charging is stopped for all, battery units BU is as short as approximately several hundred milliseconds to several seconds.

On the other hand, if charging into all battery units BU connected to the control unit CU has been stopped, then the processing advances to step St33. At step St33, a battery unit BU having the highest rank for charging at the present point of time is searched for. In particular, a battery unit BU having the highest rank for charging at a point of time at which the control unit CU tries to issue an instruction is searched for. Then at step St34, a charging instruction is issued only to the searched out battery unit BU.

After a charging instruction is issued to the designated battery unit BU at step St34, the processing advances to step St35, at which the unit number change flag is reset.

After the charging mode comes to an end, the processing is returned to the repetition of the connection ID application sequence and the state monitoring sequence.

If it is decided at step St31 that the number of battery units BU connected to the control unit CU has not changed, then the processing advances to step St37. That the number of battery units BU connected to the control unit CU has not changed signifies that, when the state at present is compared with the state in the immediately preceding charging mode, only it is necessary to take the possibility that the ranking for charging may be changed into consideration. At this time, it is assumed that the number of battery units BU to which a charging instruction has been issued already is n.

At step St37, it is decided whether or not a charging instruction has already been issued to a battery unit BU having the (n+1)th rank for charging at the point of time at which the control unit CU tries to issue an instruction. For example, if charging into two battery unit BU is being carried out already, then it is decided whether or not a charging instruction has been issued already at the battery unit BU which has the third rank for charging at the point of time at which the control unit CU tries to issue an instruction.

It is to be noted that the control unit CU has information relating to the number of battery units BU to which a charging instruction has been issued already in addition to information relating to the ranking for charging at the point of time at which the control unit CU tries to issue an instruction. In particular, for example, the control unit CU retains setting instruction information relating to on/off of the electron switches of the battery units BU.

If charging into the battery unit BU to which a charging instruction is to be issued has been carried out, or in other words, if a charging starting instruction has been issued already, then a battery unit BU which seems most appropriate as a target of charging is searched for at step St38. In particular, the control unit CU selects, from among those battery units BU having the first to nth ranks for charging at the point of time at which the control unit CU tries to issue an instruction, one battery unit BU which seems most appropriate as a target of charging.

Then, after a battery unit BU which is considered most appropriate as a target of charging is selected, the control unit CU issues a charging instruction to the selected battery unit BU.

More particularly, those battery units BU to which a charging instruction has not been issued are searched for in the descending order of the rank for charging from among the battery units BU having the first to nth ranks for charging at the point of time at which the control unit CU tries to issue an instruction. This is because the n battery units BU having higher ranks than the battery unit BU having the (n+1)th rank at the point of time at which the control unit CU tries to issue an instruction ought to include a battery unit BU to which a charging starting instruction has not been issued.

Accordingly, the n battery units BU having ranks higher than the battery unit BU having the (n+1)th rank are checked in order beginning with the battery unit BU having the highest rank for charging. Then, if a battery unit BU to which a charging starting instruction has not been issued as yet is found out, then the control unit CU instructs only the battery unit BU to discharge at step St39.

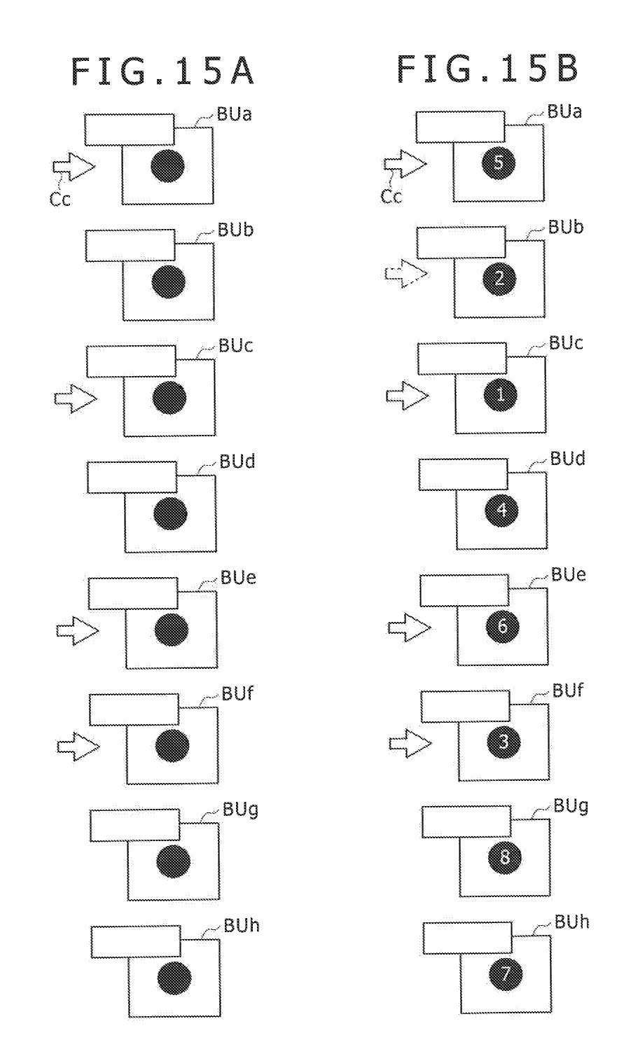

FIGS. 15A and 15B are schematic views illustrating a relationship of the ranking for charging to charging instruction to the battery units BU and charging into the battery units BU. FIG. 15B particularly illustrates a relationship of the ranking for charging to the battery units BU into which charging is being carried out at a point of time at which the control unit CU tries to issue an instruction. FIG. 15A illustrates an example of a state in a charging mode in the immediately preceding operation cycle to the state illustrated in FIG. 15B.

Now, it is assumed that eight battery units BU are connected to the control unit CU as seen in FIG. 15A and a charging instruction has been issued to four ones of the eight battery units BU (n=4). It is to be noted that, in FIGS. 15A and 15B, charging into a battery unit Bu is schematically shown by an arrow mark Cc.

In this instance, it is assumed that the number of those battery units Bu which is to carry out charging is increased by one so that charging is carried out into totaling five battery units BU.

In this instance, at a point of time at which the control, unit CU tries to issue a charging instruction newly to a battery unit BU, charging into the four battery units BU is being carried out already. At this time, the control unit CU checks whether or not charging into the battery unit BUa which has the fifth rank for charging is being carried out at the point of time at which the control unit CU tries to issue an instruction.

Here, it is assumed that, at the point of time at which the control unit CU tries to issue an instruction, charging is being carried out for the battery unit BUa which has the fifth rank for charging, as shown in FIG. 15B. In this instance, the control unit CU finds that a charging instruction has already been issued to three ones of the seven battery units BU except the battery unit BUa which has the fifth rank for charging.

This signifies that, at the point of time at which the control unit CU tries to issue an instruction, charging is no yet being carried out for at least one of those battery units BU which have the first to fourth ranks for charging.

Therefore, the control unit CU first searches the battery units BU, which have the first to fourth ranks for charging at the point of time at which the control unit CU tries to issue an instruction, successively in order beginning with the battery unit BU having the first rank for charging. Then, if a battery unit BU to which an instruction to start charging has not been issued is found, then the control unit CU issues a charging instruction only to the thus found battery unit BU. Accordingly, in the case illustrated in FIG. 15B, the control unit CU issues an instruction to start charging to the battery unit BUb which has the second rank for charging at the point of time at which the control unit CU tries to issue an instruction.

On the other hand, if charging into the battery unit BU which has the (n+1)th rank for charging at the point of time at which the control unit CU tries to issue an instruction is not yet being carried out, then the processing advances to step St40. At step St40, the control unit CU issues an instruction to start charging to the battery unit BU which has the (n+1)th rank for charging at the point of time at which the control unit CU tries to issue an instruction.

This is because, when charging into the battery unit BU which has the (n+1)th rank for charging at the point, of time at which the control unit CU tries to issue an instruction is not yet being carried out, even if an instruction to start charging is simply issued to the battery unit BU which has the (n+1)th rank for charging, there is no problem. It is to be noted that it is not guaranteed that the battery unit BU having the (n+1)th rank for charging at the present point of time has had the (n+1)th rank in the charging mode in the preceding operation cycle. However, since charging is already carried out for n battery units BU, from a point of view that a target of charging is designated based on the ranking for charging at the present point of time, it is considered reasonable to select the battery unit BU which has the (n+1)th rank at the present point of time.

Naturally, there is the possibility that a battery unit BU which is more optimum than the battery unit BU of the (n+1)th rank may exist. However, from the fact that the ranking is switched at the present point of time, it can be decided that the difference is at most as great as that of a noise level in A/D conversion. Accordingly, even if a battery unit BU which is more optimum than the battery unit BU of the (n+1)th rank exists at the present point of time, it is considered that there is no great different even if the battery unit BU of the (n+1)th rank is selected at the present point of time.

It is to be noted that, although the description of the process at step St37 in the present example is given assuming that a battery unit BU of a charging target is added newly, it may be decided at a preceding stage whether or not a charging instruction for the addition should be issued. In particular, between steps St31 and St37, it may be decided whether or not a charging instruction for the addition is to be issued in accordance with an electric power generation situation of the electric power generation section which generates electric power in response to an environment. In this instance, only when it is decided that an instruction to charge electric power additionally is to be issued because the generated electric power amount is great, the process at step St37 may be carried out. Further, a process may be added to issue, when the generated electric power amount of the electric power generation section which generates electric power in response to an environment decreases, an instruction to stop charging to the battery units BU in order beginning with the battery unit BU of the (n+1)th rank added last. In this instance, in order to make preparations for further decrease of the generated electric power amount, it is preferable to make preparations for issuance of an instruction to stop charging also to a battery unit BU which has a higher rank than the (n+1)th rank.

As schematically illustrated in FIGS. 15A and 15B, the control unit CU does not have information regarding the ranking for charging in a charging mode in the preceding operation cycle to a point of time at which the control unit CU tries to issue a charging instruction to a certain battery unit. However, the control unit CU has information regarding the ranking for charging at the point of time at which the control unit CU tries to issue an instruction and information regarding the number of battery units BU to which a charging instruction has been issued already.

Accordingly, if the procedure described above is followed, then at a point of time at which the control unit CU tries to issue an instruction, the control unit CU can issue an instruction to a battery unit BU which is considered appropriate as a target of charging at the point of time based on the information regarding the ranking for charging.

By successively issuing a charging instruction in accordance with the procedure described above until a desired number of battery units BU is reached, it is prevented for the control unit CU to issue a charging instruction in an overlapping relationship to the same battery unit BU. Also it is prevented to issue a charging instruction to a battery unit BU having a low rank for charging.

### [Discharging Procedure for a Plurality of Battery Units]

Now, description is given of a discharging procedure of the embodiment of the present disclosure. In the procedure described below, the number of battery units BU to be used for discharging is increased newly.

According to the discharging procedure of the embodiment of the present disclosure, different from the charging procedure described above, if a battery unit BU is newly connected or disconnected before a discharging instruction is issued from the control unit CU to a certain battery unit BU, then cancellation of discharging from all battery units BU is not carried out. In other words, upon transition from a discharging mode to a next discharging mode, discharging at least from one battery unit BU continues.

Generally, if a battery unit BU is newly connected or disconnected before a discharging instruction is issued from the control unit CU to a certain battery unit BU, then the control unit CU successively cancels discharging from any other battery unit BU than one battery unit BU. After the discharging from all of the other battery units BU is canceled, unless a battery unit BU is newly connected or disconnected, the control unit CU successively issues a discharge starting instruction to the battery units BU until the number of battery units BU to which a discharging instruction is to be issued is reached.

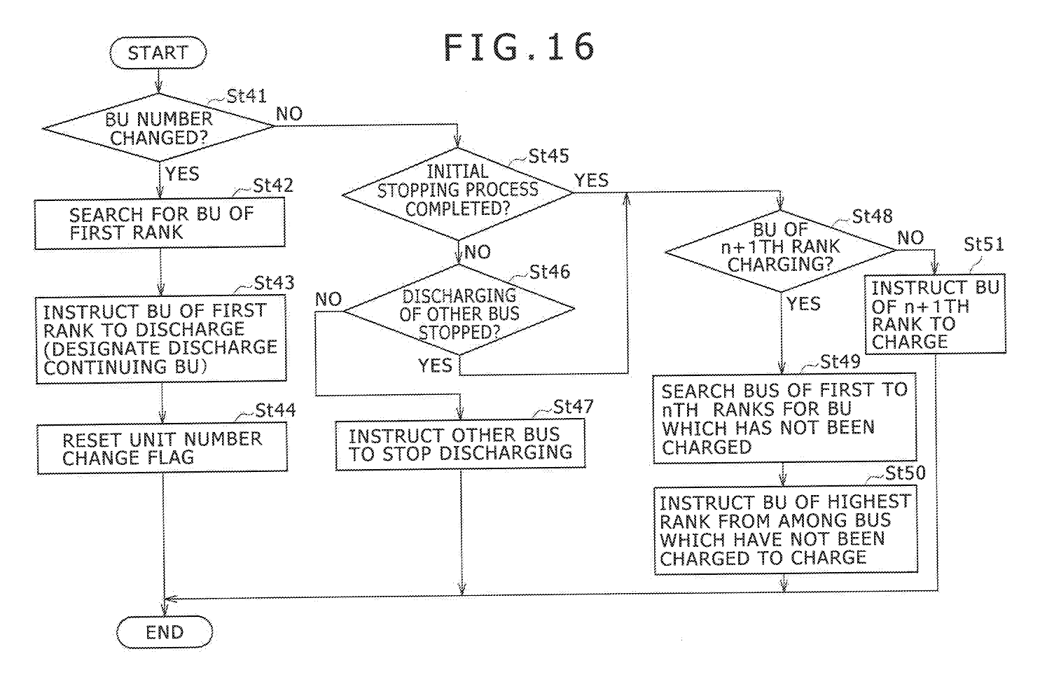

FIG. 16 is a flow chart illustrating an example of a process when a discharging instruction is issued to a plurality of battery units based on the ranking for discharging. The series of processes described below is executed, for example, by the CPU 13 of the control unit CU.

As described hereinabove, the control system 1 does not, enter a mode in which discharging can be carried out unless verification of a state of all of the battery units BU connected to the control unit CU at the present point of time comes to an end. In other words, when the variable Nb and the variable Nt mentioned hereinabove coincide with each other, the control system 1 enters a mode in which discharge can be carried out. It is to be noted that, if the variable Nb and the variable Nt do not coincide with each other, then the processing is returned to a repetition of the connection ID application sequence and the state monitoring sequence. In the following description, the mode in which discharge can be carried out is referred to suitably as “discharging mode.”

In the discharging mode, it is decided first at step St41 whether or not the number of battery units BU connected to the control unit CU has changed. In particular, for example, it is decided whether or not the unit number change flag exhibits a set state.

If the number of battery units BU connected to the control unit CU has changed, then the processing advances to step St42. On the other hand, if the number of battery units BU connected to the control unit CU has not changed, then the processing advances to step St45.

If the number of battery units BU connected to the control unit CU has changed, then the battery unit BU of the highest rank for discharging at the present point of time is searched for at step St42. In particular, the battery unit BU having the first rank for discharging at a point of time at which the control unit CU tries to issue an instruction is searched for. Then at step St43, a discharging instruction is issued only to the searched out battery unit BU. In the following, the battery unit BU to which an instruction to start discharging is issued at step St43 is hereinafter referred to as discharge continuing battery unit BU.

After designation of a discharge continuing battery unit BU is carried out at step St43, the processing advances to step St44, at which the unit number change flag is reset. It is to be noted that, as occasion demands, the number of discharge continuing battery units BU may be two or more such that the processing then advances to a step at which the discharging instruction to the other battery units BU is stopped. Whether or not a discharging instruction is to be issued to two or more battery units BU, or in other words, whether or not the number of discharge continuing battery units BU is set to two or more, is set suitably in response to the electric power amount required by the connected load.

After the discharging mode ends, the processing returns to a repetition of the connection ID application sequence and the state monitoring sequence.

On the other hand, if is decided at step St41 that the number of battery units BU connected to the control unit CU does not exhibit a change, then the processing advances to step St45.

At step St45, it is decided whether or not the discharging stopping process after the discharging instruction has been issued to the discharge continuing battery unit BU (the process is hereinafter referred to suitably as initial stopping process) is completed. The initial stopping process is a process of successively stopping, after the discharge continuing battery unit BU is designated, discharging from the other battery units BU than the discharge continuing battery unit BU. If the initial stopping process is not completed as yet, then the processing advances to step St46. On the other hand, if the initial stopping process is completed at step St45, then the processing advances, to step St48. It is to be noted that, also in the case where discharging from the battery units BU from which discharging is to be carried out is carried out already and besides neither new connection nor disconnection of a battery unit BU is found, the processing advances to step St48.

At step St46, it is decided whether or not discharging from all battery units BU except the battery unit BU to which the discharging instruction was issued at step St43, namely, except the discharge continuing battery unit BU, stops. If a battery unit BU which continues discharging is found, then a command to stop discharging is signaled to the battery unit BU which continues discharging at step St47.

In short, in the present example, when the control system 1 is in a mode in which discharging takes priority, if the number of battery units BU changes, then an instruction to start discharging is issued to the battery unit BU which has the first rank for discharging at a point of time at which a discharging mode is entered. If the control system 1 enters the discharging mode again by a repetition of the connection ID application sequence and the state monitoring sequence, then the discharging from the battery units BU other than, the battery unit BU to which the discharge starting instruction was issued at step St43, namely, other than the discharge continuing battery unit BU, is successively canceled. If the discharging from all battery units BU other than the discharge continuing battery unit BU is canceled, then the initial stopping process is completed therewith.

The reason why, different from the charging process described hereinabove, discharging from all battery unit BU is not canceled once is that it is intended to continue the supply of electric power from the control unit CU to the external apparatus.

It is to be noted that, in the control system 1, also it is possible to carry out, while discharging from a certain battery unit BU is carried out, charging into another battery unit BU. For example, also it is possible to carry out charging from a certain battery unit BU to another battery unit BU. Therefore, a charging stopping command may be signaled together with a discharging stopping command.

If discharging from all battery units BU other than the discharge continuing battery unit BU stops, then the processing advances to step St48.

At step St48, it is decided whether or not a discharging instruction has been issued already to the battery unit BU having the (n+1)th rank for discharging at a point of time at which the control unit CU tries to issue an instruction.

It is to be noted that the control unit CU has information regarding the number of battery units BU to which a discharging instruction has been issued already in addition to information regarding the ranking for discharging at a point of time at which the control unit CU tries to issue an instruction. In particular, for example, the control unit CU retains information of setting instructions regarding on/off of the electronic switches of the battery units BU.

If discharging from the battery unit BU to which a discharging instruction is to be provided is carried out already, namely, if a discharging starting instruction has been issued already, then a battery unit BU which is considered most appropriate as a target of discharging is searched for at step St49. In particular, similarly as in the case of the charging process described hereinabove, n battery units BU having ranks for discharging higher than the battery unit BU of the (n+1)th rank for discharging are checked first in the descending order of the rank for discharging. Then, if a battery unit BU to which a discharging starting instruction has not been issued as yet is found out, then a discharging instruction is issued only to the found out battery unit BU at step st50.

On the other hand, if discharging from the battery unit BU having the (n+1)th rank for discharging at a point of time at which the control unit CU tries to issue an instruction is not carried out as yet, then the processing advances to step St51. At step St51, a charging starting instruction is issued to the battery unit BU having the (n+1)th rank for discharging at a point of time at which the control unit CU tries to issue an instruction.

After the discharging mode comes to an end, the processing is returned to a repetition of the connection ID application sequence and the state monitoring sequence.

If the procedure described above is followed, then an instruction can be provided to a battery unit BU which is considered appropriate as a target of discharging at a point of time at which the control unit CU tries to issue an instruction based on information regarding the ranking for discharging at the point of time.

By successively issuing a discharging instruction to the battery units BU in accordance with the procedure described above until a desired number of battery units is reached, the control unit CU can be prevented from signaling a discharging instruction in an overlapping relationship to the same battery unit BU. Also it can be prevented to signal a discharging instruction to a battery unit BU having a low rank for discharging.

As apparent from the foregoing description, in the discharging mode, even if the number of battery units BU connected to the control unit CU changes, a battery unit BU which continues discharging exists. Accordingly, the continuity of discharging is guaranteed, and supply of electric power from the control unit CU to the external apparatus is not interrupted.

It is to be noted that there is no problem even if a battery unit BU having a sufficient battery remaining capacity discharges in the charging mode or even if charging into a battery unit BU having a small battery remaining capacity is carried out in the discharging mode. Further, in the control system 1, also it is possible to carry out discharging from a certain battery unit BU while charging into another battery unit BU is carried out. For example, also it is possible to carry out charging from a certain battery unit BU into another battery unit BU. Therefore, in both of the charging mode and the discharging mode, discharging from a battery unit BU having a sufficient battery remaining capacity and charging into a battery unit BU having a small battery remaining capacity may be carried out simultaneously.

As described above, according to the embodiment of the present disclosure, it is possible to carry out charging/discharging from/into a plurality of batteries in an appropriate order based on a ranking for charging/discharging at the present point of time. Further, according to the embodiment of the present disclosure, since the number and state of battery units BU for each charging/discharging instruction need not be retained, the battery units can carry out charging/discharging in an appropriate order without increasing the memory capacity without limitation.

It is to be noted that while the description given above relates to an example wherein the ranking for charging/discharging is determined based on the battery remaining capacity, the parameter for determining the ranking for charging/discharging may be set arbitrarily like the temperature of the battery units BU or the number of times of charging/discharging.

### 2. MODIFICATIONS

Although the embodiment of the present disclosure has been described, the present disclosure is not limited to the embodiment described above but can be modified in various forms. All of the configurations, numerical values, materials and so forth in the present embodiment are mere examples, and the present disclosure is not limited to the configurations and so forth given as the examples. The configurations and so forth given as the examples can be suitably changed within a range within which no technical contradiction occurs.

The control unit and the battery unit in the control system may be portable. The control system described above may be applied, for example, to an automobile or a house.

It is to be noted that the present disclosure may have such configurations as described below.

(1)

A charge controlling method, wherein, when charging into at least one of a plurality of charging apparatus each including a battery is to be started, if it is detected that at least one of the charging apparatus is connected or disconnected, then charging into all of the charging apparatus is stopped.

(2)

The charge controlling method according to (1), wherein, after the charging into all of the charging apparatus is stopped, charging into the charging apparatus is successively started in accordance with ranks determined currently based on states of the batteries provided in the charging apparatus.

(3)

The charge controlling method according to (1) or (2), wherein, if connection or disconnection of at least one of the plurality of charging apparatus is not detected, then whether or not charging into the charging apparatus which has the (n+1)th rank determined based on states of the batteries provided in the charging apparatus when charging is started is carried out is decided, n being a natural number representative of the number of those charging apparatus which have already started charging.

(4)

The charge controlling method according to (3), wherein,

if charging into the charging apparatus having the (n+1)th rank has been started, then charging into the charging apparatus whose charging has been stopped and which has the highest rank from among the charging apparatus which have the first to nth ranks is started, but

if charging into the charging apparatus having the (n+1)th rank for charging has not been started, then charging into the charging apparatus having the (n+1)th rank for charging is started.

(5)

The charge controlling method according to any one of (2) to (4), wherein the ranks are determined based on battery remaining capacities of the batteries provided in the charging apparatus.

(6)

The charge controlling method according to any one of (1) to (5), wherein battery remaining capacities of the batteries provided in the charging apparatus are verified to detect connection or disconnection of at least one of the charging apparatus.

(7)

A discharge controlling method, wherein, when discharging from at least one of a plurality of discharging apparatus each including a battery is to be started, if connection or disconnection of at least one of the discharging apparatus is detected, then discharging from one of the discharging apparatus is continued while discharging from all of the remaining discharging apparatus is stopped.

(8)

The discharge controlling method according to (7), wherein, when the one discharging apparatus continues the discharging, the one discharging apparatus has a first rank from among ranks determined based on states of the batteries provided in the discharging apparatus.

(9)

A charging apparatus controller, wherein, when the charging apparatus controller issues an instruction to start charging into at least one of a plurality of charging apparatus each including a battery and being capable of being connected to and disconnected from the charging apparatus controller, if new connection or disconnection of at least one of the charging apparatus is detected, the charging apparatus controller issues an instruction to stop charging to all of the charging apparatus.

(10)

A discharging apparatus controller, wherein, when the discharging apparatus controller issues an instruction to start discharging to at least one of a plurality of discharging apparatus each including a battery and capable of being connected to and disconnected from the discharging apparatus controller, if new connection or disconnection of at least one of the discharging apparatus is detected, then the discharging apparatus controller causes at least one of the discharging apparatus to continue discharging and issues an instruction to stop discharging to all of the remaining discharging apparatus.

(11)

A charge controlling program for causing a computer to execute stopping, when charging into at least one of a plurality of charging apparatus each including a battery is to be started, charging into all of the charging apparatus if it is detected that at least one of the charging apparatus is connected or disconnected.

(12)

A discharge controlling program for causing a computer to execute continuing, when discharging from at least one of a plurality of discharging apparatus each including a battery is to be started, discharging from one of the discharging apparatus while stopping discharging from all of the remaining discharging apparatus if connection or disconnection of at least one of the charging apparatus is detected.

The present disclosure contains subject matter related to that disclosed in Japanese Priority Patent Application JP 2011-243966 filed in the Japan Patent Office on Nov. 7, 2011, the entire content of which is hereby incorporated by reference.

What is claimed is:

1. A charge controlling method, wherein, when charging into at least one of a plurality of charging apparatus each including a battery is to be started, if it is detected that at least one of the charging apparatus is connected or disconnected, then charging into all of the charging apparatus is stopped.

2. The charge controlling method according to claim 1, wherein, after the charging into all of the charging apparatus is stopped, charging into the charging apparatus is successively started in accordance with ranks determined currently based on states of the batteries provided in the charging apparatus.

3. The charge controlling method according to claim 2, wherein the ranks are determined based on battery remaining capacities of the batteries provided in the charging apparatus.

4. The charge controlling method according to claim 1, wherein, if connection or disconnection of at least one of the plurality of charging apparatus is not detected, then whether or not charging into the charging apparatus which has the (n+1)th rank determined based on states of the batteries provided in the charging apparatus when charging is started is carried out is decided, n being a natural number representative of the number of those charging apparatus which have already started charging.

5. The charge controlling method according to claim 4, wherein,
if charging into the charging apparatus having the (n+1)th rank has been started, then charging into the charging apparatus whose charging has been stopped and which has the highest rank from among the charging apparatus which have the first to nth ranks is started, but
if charging into the charging apparatus having the (n+1)th rank for charging has not been started, then charging into the charging apparatus having the (n+1)th rank for charging is started.

6. The charge controlling method according to claim 1, wherein battery remaining capacities of the batteries provided in the charging apparatus are verified to detect connection or disconnection of at least one of the charging apparatus.

7. A discharge controlling method, wherein, when discharging from at least one of a plurality of discharging apparatus each including a battery is to be started, if connection or disconnection of at least one of the discharging apparatus is detected, then discharging from one of the discharging apparatus is continued while discharging from all of the remaining discharging apparatus is stopped.

8. The discharge controlling method according to claim 7, wherein, when the one discharging apparatus continues the discharging, the one discharging apparatus has a first rank from among ranks determined based on states of the batteries provided in the discharging apparatus.

9. A charging apparatus controller, wherein, when the charging apparatus controller issues an instruction to start charging into at least one of a plurality of charging apparatus each including a battery and being capable of being connected to and disconnected from the charging apparatus controller, if new connection or disconnection of at least one of the charging apparatus is detected, the charging apparatus controller issues an instruction to stop charging to all of the charging apparatus.

10. A discharging apparatus controller, wherein, when the discharging apparatus controller issues an instruction to start discharging to at least one of a plurality of discharging apparatus each including a battery and capable of being connected to and disconnected from the discharging apparatus controller, if new connection or disconnection of at least one of the discharging apparatus is detected, then the discharging apparatus controller causes at least one of the discharging apparatus to continue discharging and issues an instruction to stop discharging to all of the remaining discharging apparatus.

11. A charge controlling program for causing a computer to execute stopping, when charging into at least one of a plurality of charging apparatus each including a battery is to be started, charging into all of the charging apparatus if it is detected that at least one of the charging apparatus is connected or disconnected.

12. A discharge controlling program for causing a computer to execute continuing, when discharging from at least one of a plurality of discharging apparatus each including a battery is to be started, discharging from one of the discharging apparatus while stopping discharging from all of the remaining discharging apparatus if connection or disconnection of a least one of the charging apparatus is detected.
